(19) United States
(12) Patent Application Publication
(10) Pub. No.: US 2019/0169953 A1
(43) Pub. Date: Jun. 6, 2019

(54) MOLDED DEGRADABLE DOWNHOLE TOOL ELEMENTS

(71) Applicant: MAGNUM OIL TOOLS INTERNATIONAL, LTD., Corpus Christi, TX (US)

(72) Inventor: W. Lynn Frazier, Corpus Christi, TX (US)

(21) Appl. No.: 16/211,847

(22) Filed: Dec. 6, 2018

Related U.S. Application Data
(60) Provisional application No. 62/595,299, filed on Dec. 6, 2017.
(60) Provisional application No. 62/625,099, filed on Feb. 1, 2018.

(51) Int. Cl. E21B 33/12

(52) U.S. Cl. CPC E21B 33/1208; B29C 45/14311

(57) ABSTRACT

A two-part structural element for a downhole tool is disclosed, and methods of making the same. The two parts are a moldable plastic second part and a first part being an insert for placement in a mold, typically before a thermoset or thermoplastic second part is poured or otherwise placed in the mold. One or both of the two parts may be degradable in a downhole fluid.

This application claims priority from and the benefit of No. 62/595,299, filed Dec. 6, 2017, and Application No. 62/625,099, filed Feb. 1, 2018, both of which are incorporated herein by reference.

### BACKGROUND OF THE INVENTION

Oil and gas well completion operations employ many downhole tools, for example, bridge plugs, frac plugs and cement retainers for zonal isolation and other tasks. However, especially in deeper wells, fracking processes require high strength in the elements comprising settable downhole tools. It is sometimes necessary to design strong components for downhole tools to meet high-pressure requirements. Following fracking, it may be necessary for the tool to be removed. This may be done by milling the tool out. However, making the downhole tool stronger to meet high-pressure requirements may make milling the downhole tool out more difficult. Recently, downhole tools have been developed that dissolve in downhole fluids rather than needing to be milled out. See U.S. Patent Publication Nos. US2017-0030161, published Feb. 2, 2017, and US2017-0234103, published Aug. 17, 2017, all incorporated herein by reference.

A method of making downhole tool parts is to machine them from billets made of composite or partly composite materials such as fiberglass and resin, or of non-composite materials, such as polyglycolic acid, polylactic acid or other polymer acid.

Structural parts for downhole tools may be injection molded, compression molded, or over molded. Examples of injection molding of downhole tool parts are found in US 2014/0116677 incorporated herein by reference. This publication shows a solid, non-metallic insert, which is injection molded, over molded or compression molded for use as the interior portion of a cone assembly in a settable downhole tool.

### SUMMARY OF THE INVENTION

A compound part is a part or structural element of a downhole tool, such as a mandrel, slip, cone or ring, having been formed by a plastic molding method in which an insert, capable of withstanding the molding process is combined with a thermoplastic or thermoset second part. After setting or curing, the two parts are physically identifiable in the structural element, the first part having withstood the molding process. The molding process may be injection molding, compression molding, overmolding, insert molding, extrusion molding, centrifugal molding or any other suitable molding process. Typically, in some embodiments one or both of the parts are degradable in a downhole fluid such that the tool either does not need to be milled out or is easier to mill out.

In some embodiments, Applicant discloses a structural element for a settable downhole tool, the structural element comprising: a first part comprising a metal degradable in a downhole fluid configured to fit or be shaped into an injection mold; and a second part comprising an injection moldable material; wherein the settable downhole tool will release from a well's casing more quickly, at the same rate, or more slowly than if the structural element were comprised solely of the injection moldable material; wherein the settable downhole tool will be more millable after two hours in aqueous downhole fluid than if the structural element was comprised solely of the injection moldable material.

In some embodiments, Applicant discloses the first part is comprised of a material capable of withstanding the molding process and having voids for receiving injected second part material and being part of an injection molded structural element of the downhole tool. The second part is comprised of an injection moldable material capable of being part of an injection molded structural element of the downhole tool and capable of being injected into first part voids when the first part is in a mold. The first and second parts are collectively capable of being molded together in the mold to produce an injection molded structural element of the downhole tool. The structural and mechanical properties of the first part and the second part are different.

In some embodiments the first part is placed within a mold, the second part flowed within the first part in the mold, molding of the first and second parts within the mold occurs, the mold is opened, and the resulting injection molded structural element of a downhole tool is produced. The structural and mechanical properties of the first part and the second part are different. In some embodiments the first part is or is not substantially degradable, provides or does not provide greater compression or shear strength to the structural element of the downhole tool relative to the second part, and is easier or harder to mill up than the second part.

The first part may comprise a degradable skeleton. The term “skeleton” as used herein is defined as “a body having one or more voids capable of receiving an injection moldable material during injection molding, the body capable of being a first part of an injection molded structural element of a downhole tool and the injection moldable material capable of being a second part of the injection molded structural element of a downhole tool.”

The context or specific limitations stated herein may further define skeleton, such as it comprising compressed or molded shavings, pieces or granules; different confirmations of wire, rigid or nonrigid; ordered, unordered; woven, or knitted wire mesh; or structures with cavities, fins, matrixes or cellular structures, all having one or more voids capable of receiving injection moldable second part material by injection molding to comprise an injection molded structural element of the downhole tool.

Some skeletons may have all of their voids filled with the injection moldable second part. Other skeletons may have only a portion of their voids filled with the injection moldable second part. Other skeletons may receive the injection moldable second part within only an outer area of the skeleton, leaving an inner void within the skeleton, or filling the first part about an inner court within the first part. Other skeletons may be formed from or into structures which have one or more voids capable of receiving the second part by an injection molding.

In some embodiments the skeleton is an open metallic skeleton comprised of reactive metal, including, without limitation, magnesium or aluminum or alloys. A rigid, open cell skeleton may be foam metal. An at least partly open cell skeleton may be made of metal wire, such as wherein the wire is aluminum or magnesium. The diameter of the wire may, in some embodiments, be between about 2 and 250 mil. The wire may be an ordered wire mesh, including a woven wire mesh or knitted wire mesh. The knitted wire mesh may be die compressed. The first part may be a granular metal. The granular metal may be magnesium. The first part may be a rigid, solid insert. The first part may comprise randomly interwoven metal fiber. The interwoven fibers may be die pressed.

In some embodiments the second part may be a polymer degradable in a downhole fluid. The polymer may be a polymer acid including, for example, polylactic acid or polyglycolic acid. In some embodiments the second part may be elastomeric or non-elastomeric, for example, an elastomeric material used as part of the tool's seal against the casing, a polymer which is not appreciably degradable, or other materials useful as structural elements of the downhole tool. In some embodiments the second part is or is not substantially degradable, provides or does not provide greater compression or shear strength to the structural element of the downhole tool relative to the first part, and is easier or harder to mill up than the first part.

In some embodiments, the structural element of the downhole tool, comprised of the first part of the second part, is more easily millable than a similar element comprised of conventional materials, or comprised of only the first part material, or comprised of only the second part material.

A method of making a structural element for a downhole tool is disclosed, the method comprising the steps of: providing a mold having a mold cavity; partly filing the cavity with a first material comprising an insert, the insert comprising a metal dissolvable in a downhole fluid; injecting the mold cavity with a second material, the second injectable material comprising an injectable material in a plastic or fluid state, the second material at least partly encapsulating the first material; and at least partly filling the mold allowing the second material to cure or set; and removing the structural element therefrom. The first material may be made of aluminum or magnesium wire. The wire may be die pressed before the partly filling step.

A structural element for a settable downhole tool, the structural element comprising: a first part comprising a metal degradable in a downhole fluid configured or shaped to fit into an injection mold; and a second part comprising an injection moldable material; wherein the settable downhole tool will release from a well's casing more quickly than if the structural element were comprised solely of the injection moldable material; wherein the settable downhole tool will be more millable after two hours in aqueous downhole fluid than if the structural element was comprised solely of the injection moldable material.

A structural element for a downhole tool, comprising: a first part and a second part; the first part comprising, in some embodiments, a metal degradable in an aqueous downhole fluid and capable of being used in an injection mold with the second part, the first part comprising a matrix and disposed within the structural element so when the tool is used in an aqueous downhole fluid at least some outer portions of the first part are at the outer surface of the structural element are in contact with the aqueous downhole fluid and at least some inner portions of the first part are not in contact with the aqueous fluid; the second part comprising an injection moldable material, in some embodiments, degradable in an aqueous downhole fluid; the second part disposed within the structural element so when the tool is used in an aqueous downhole fluid at least some inner portions of the first part are not in contact with the aqueous downhole fluid; the first part degrades more quickly in aqueous downhole fluid than the second part, and degradation of the first part increases the surface area of the second part in contact with the aqueous downhole fluid; and the structural element degrades more quickly in the aqueous downhole fluid than a similar structural element comprised solely of the second part injection moldable material will degrade.

This application's structural element for a downhole tool includes any of the tool's elements which provide structural compression or shear strength during use or setting of the tool downhole, including, without limitation, the mandrel, cones, rings, seal (elastomeric or non-elastomeric), ball, wedges, slips, shoes, middle, top, bottom and the like.

### BRIEF DESCRIPTION OF THE DRAWINGS

FIG. 1A illustrates a compound or two part structural element for use in a settable downhole tool or other downhole tool.

FIG. 1B illustrates an insert, which is part of the structural element of FIG. 1A.

FIG. 1C illustrates a die pressed knitted wire mesh insert for use as a rigid insert.

FIG. 2A illustrates an embodiment of an open cell, non-rigid insert.

FIG. 2B illustrates a billet which may be machined to form a structural element.

FIG. 3 illustrates an injection molding machine that may be used to make structural elements.

FIGS. 4A, 4B, and 4C illustrate the manner of molding various structural elements disclosed herein.

FIG. 5A illustrates a stiff, open or partially open cell foam metal insert.

FIG. 5B illustrates a particulate, granular, degradable metallic material for use with forming some embodiments of the structural elements disclosed herein.

FIG. 5A1 illustrates a wire mesh insert comprised of randomly oriented wires or fibers for use as an insert in some embodiments disclosed herein.

FIG. 5B1 illustrates a knitted wire mesh insert, which may be flexible rigid.

FIG. 5C illustrates a woven wire mesh insert, which may be flexible rigid.

FIG. 5C1 illustrates a close-up of a herringbone weave of the woven wire mesh insert of FIG. 5C.

FIGS. 6A, 6B, and 6C illustrate various forms of die pressed metallic inserts for use in some embodiments disclosed herein of structural elements for downhole tools.

FIG. 7 illustrates a die punch and die cavity for use in making die pressed inserts for structural elements disclosed herein.

FIG. 8A illustrates compression molding of a charge or preform so as to form an insert for subsequent placement in a mold.

FIG. 8B illustrates compression molding of a two-part preform and FIG. 8C illustrates compression molding comprising a first part preform for subsequent use as an insert and an injected molded structural element.

FIGS. 9A and 9B illustrate a pour molding method of making a structural element.

FIG. 10A illustrates shavings for use as a first part of a structural element.

FIG. 10B illustrates shavings packed into an injection mold.

FIG. 10C illustrates the manner in which multiple, loose first part shavings may be die pressed with a hydraulic press to form a rigid insert for placement in an open mold.

FIG. 10D shows a single metal shaving.

FIGS. 11A and 11B illustrate the manner of making a structural element wherein part of the element includes both part 11 and part 12, while other portions contain only one or the other.

FIG. 11C shows the typical hollow cylindrical shape of some embodiments of Applicant's structural elements.

FIG. 11D illustrates a structural element 10 wherein the first part is encapsulated in the second part.

FIGS. 12A and 12B (preset) as well as FIGS. 13A and 13B (post set) illustrate elastomeric packoff elements, formed with two parts, one degradable, and injection molded.

FIG. 14 illustrates a structural element with cavities.

FIG. 14A illustrates a process of degradation of a structural element in a downhole fluid wherein some portions of some first parts are exposed to the downhole fluid upon initial contact with downhole fluid.

FIGS. 15A and 15B illustrate a multi-filament fiber and a monofilament fiber, respectively, for use as an insert.

FIGS. 15C and 15D illustrate the use of multiple oriented fibers forming an array for insertion into a mold.

### DETAILED DESCRIPTION OF THE PREFERRED EMBODIMENTS

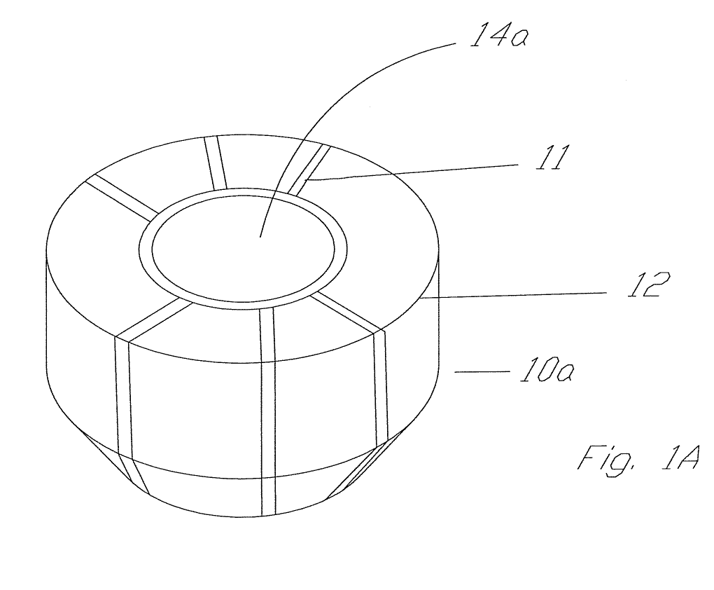

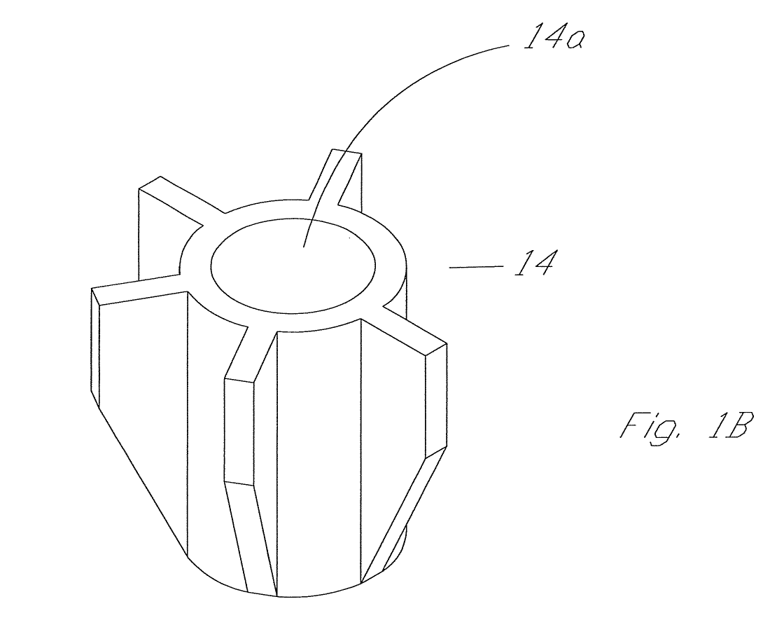

FIG. 1A shows a compound part or structural element 10 such as a cone, wedge, packoff or sealing element, mandrel, ring, shoe, back-up ring or other elements for use in a settable downhole tool. In some embodiments, these structural elements are non-frangible—that is—not shear rings or shear rings subject to breaking up under shear loading. Structural element 10 is capable of being made by molding and has at least a first part 11 and a second part 12 and, in some embodiments, only a first part and a second part. First part 11 is comprised, in some embodiments, of a degradable metal or degradable non-metal capable of and configured to be used or placed in a mold prior to or during injection molding of structural element 10. A second part or second material is a material, typically a thermoset or thermoplastic composition, that may be molded and will subsequently set or cure. At least one part is typically degradable. In some embodiments, first part 11 may be comprised of a degradable metal (“metal” means a pure metal or a metallic alloy), such as magnesium, aluminum or the like, including SoluMag from Magnesium Elektron which is degradable in downhole fluids. Other degradable metals include aluminum materials sold by Phenom Innovations as Wraith™, Terves Magnesium alloy TAₓ-100ₑ and Bubbletight, which offers both magnesium and aluminum alloys. Second part 12 is, in some embodiments, comprised of an injectable material capable of being injected into a mold during injection molding of structural element 10. In some embodiments, second part 12 is pour, injection or compression moldable.

Second part 12 may or may not be degradable. In some embodiments, second part 12 is a thermoplastic injectable material that may be injected into a mold, and in some embodiments comprises a thermoplastic polymer acid including degradable polyglycolic acid or polylactic acid or the like, including Kuredux from Kureha Corporation and any of the injectable or moldable materials taught by U.S. Pat. No. 6,046,251 and Publication Nos. US2016/0289374 and US2017/0306144, incorporated herein by reference. In some embodiments, second part 12 is a thermoset or thermoplastic material compatible with insert molding. In some embodiments, second part cures or sets following injection to form an elastomeric material, such as TPE

### (Thermoplastic Elastomers)

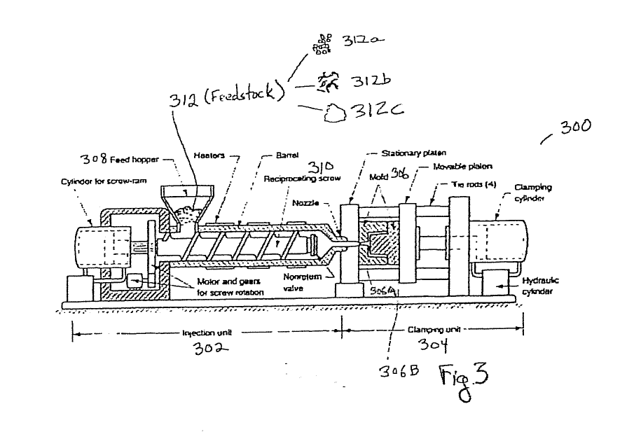

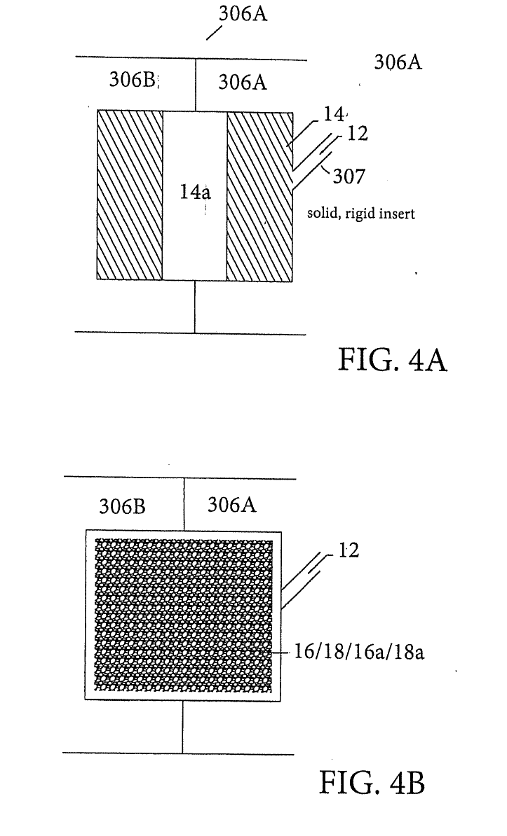

The compound part or structural element 10 is seen to have, after curing or setting at least two separate parts, physically joined into one part, without chemical reaction between the two. At least one part is injection moldable, or otherwise moldable, such as PGA or PLA or other polymer acid. An insert is placed into the mold before the second part—the injectable, except when a slurry 13 is used (see FIG. 4C).

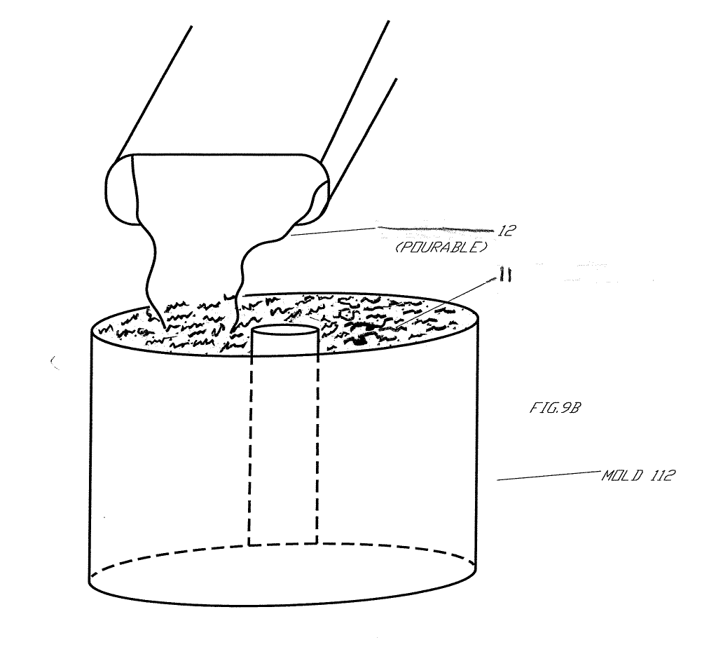

The first part is also called an insert, as it is typically inserted into the mold before the injection step and survives the cure or setting process of the second part to remain physically observable in the structural element. An insert may also be part of a slurry (see FIG. 4C and FIG. 9A). Physically an insert may be solid or have multiple openings. It may be self-supporting before insertion, holding its shape when put into the mold. It may be particulate. The second part undergoes setting or curing (cross-linking), which is typically, but not necessarily, thermal cure.

Injection molding utilizes a technique that includes an insert, typically solid, sometimes rigid, which is placed into the injection mold prior to molding, and then melted plastic material (or a pre-cured mix) is injected into the mold to fill the cavity and mold around the inserted component. Injection molding can often result in stronger, more lightweight products since the insert helps add stability and strength without the need for multiple parts.

First part 11 of structural element 10 is seen to comprise, in some embodiments, either multiple loose individual pieces—such as fibers, flakes or granules or a structurally integral element. The loose particles may be either packed into a mold or “pre-pressed” together, in which case they become structural integral element for placement into an open mold. Loose individual pieces such as shavings, fibers, flakes or granules or the like may also form an insert or first part of a slurry that is injected into an open mold mixed with the thermoplastic or thermosetting second part. Structurally integral elements may be at least partly open cell or random intertwined fiber meshes. An organized fiber mesh such as a skeleton of woven or knitted wire may also be placed in an open mold with the second part—in some embodiments, the injectable material in a preset or pre-cured condition—partially or fully filling some or all of the open spaces. The use of the two parts, one of which is degradable, may add strength to the structural element and the two parts have, in some embodiments, a synergistic relationship such that in the same downhole fluid the degradation will proceed faster than the same structural element being made of either one or the other material, rather than the combination.

In some embodiments, first part 11 may be chosen to degrade at the same rate, more quickly or more slowly in aqueous downhole fluids in a typical oil or gas well during completion operations than second part 12. In some embodiments, the settable downhole tool will release from a well's casing more quickly than if the structural element were comprised solely of an injection moldable polymer. In some embodiments, first part 11 degrades sufficiently faster than second part 12 in typical aqueous downhole fluids so downhole tool will release from the well's casing significantly sooner than if structural element 10 was comprised solely of second part 12. In one embodiment, first part 11 will degrade at least twice as quickly as second part 12 in water at 150° F. In some embodiments, the resulting settable downhole tool, in aqueous downhole fluid under typical conditions, will release from the wells casing in between about 80% to 20% of the time that would be needed for a similar tool to release in which the structural element was comprised solely of the injection moldable polymer.

In some embodiments, a settable downhole tool having a structural element 10 in which first part 11 is comprised of degradable magnesium, aluminum or the like, including SoluMag from Magnesium Elektron and second part 12 is comprised of an injection moldable degradable polymer such as polyglycolic acid, polylactic acid or the like, including Kuredux from Kureha Corporation, in aqueous downhole fluid under typical conditions, may release from the well casing in between 80% to 20% of the time that would be needed for a similar tool to release in which the structural element was comprised solely of the injection moldable degradable polymer.

In some embodiments, the resulting settable downhole tool may be more millable than if the structural element was comprised solely of an injection moldable polymer. In some embodiments, the resulting settable downhole tool may be more millable after two hours in aqueous downhole fluid than if the structural element was comprised solely of the injection moldable polymer. In some embodiments, the resulting settable downhole tool, after four hours in aqueous downhole fluid under typical conditions, may be capable of being milled out of the well casing in between about 80% to 20% of the time that would be needed to mill out a similar tool in which the structural element was comprised solely of the injection moldable polymer.

In some embodiments, a settable downhole tool having structural element 10 in which first part 11 may be comprised of degradable magnesium, aluminum or the like or a mixture of degradable aluminum or magnesium (including alloyes), including SoluMag from Magnesium Elektron and second part 12 may be comprised of a degradable polymer such as polyglycolic acid, polylactic acid or the like, including Kuredux from Kureha Corporation, after four hours in aqueous downhole fluid under typical conditions, will be capable of being milled out of the well casing in between 80% to 20% of the time that would be needed to mill out a similar tool in which the structural element was comprised solely of Kuredux.

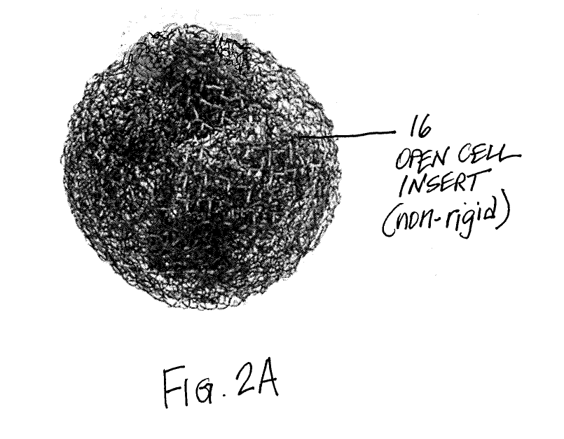

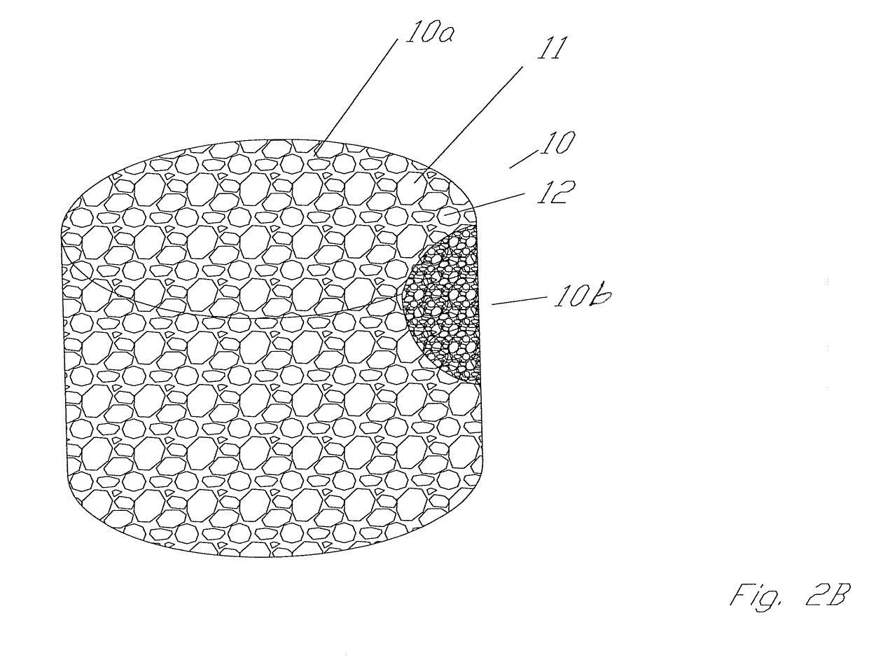

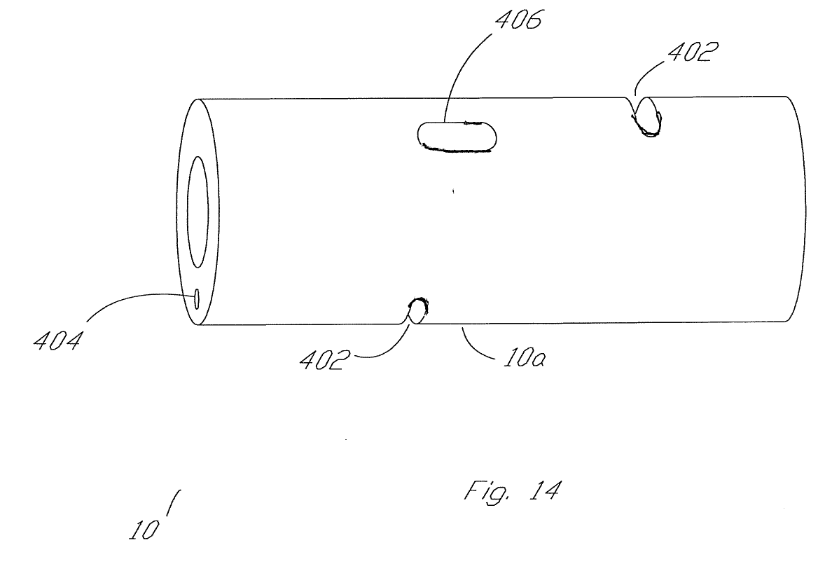

As seen in FIGS. 1A, 1B, and 2B, structural element 10 has outer surface 10a which will typically be exposed to downhole fluids when the downhole tool that structural element 10 is part of is used in a well. Outer surface 10a may, in some embodiments, be comprised partly of at least first part 11 and second part 12. When structural element 10 is exposed to downhole fluids, the downhole fluids contact portions of first part 11 which are at outer surface 10a, causing degradation of first part 11 (and second part 12 if that is exposed and degradable) (see FIG. 14A). This degradation weakens structural element 10 and creates weaknesses, cracks, channels or pits in structural element 10 (see FIG. 14A). Weaknesses accelerate exposure of second part 12 to the downhole or fluids which, in some embodiments, may accelerate degradation of second part 12 (if a degradable second part is used) by the downhole fluids relative to degradation of second part 12 in the absence of first part 11 in structural element 10. Ultimately, degradation of first part 11 and/or both the first part 11 and second part 12 sufficiently lessen the structural integrity of structural element 10 so the downhole tool releases from the well's casing. If the second part is non-degradable, degradation of the first part may cause the structural element to break into sufficiently small pieces such that flow of wellbore fluids to the surface allows their removal.

In one embodiment, the first part of structural element 10 is a reactive metal which is degradable in an aqueous downhole fluid, such as aluminum or magnesium (or their alloys), and the second part is a polymer degradable in an aqueous downhole fluid, such as PGA or PLA. Because of the intermingling of the first part in the second part degradation of the metallic first part may increase the second part's aqueous downhole fluid surface area, which accelerates degradation of the second part. Likewise, degradation of the PGA second part increases the first parts aqueous downhole fluid surface area, which accelerates degradation of the first part. From one perspective, as the overall quantity of the first part and the overall quantity of the second part become substantially reduced, their surface areas available for degradation by the aqueous downhole fluid decrease in the quantity of material degraded per unit of time decreases. As a practical matter, however, one target outcome is to speed or predetermine when the plug will decompose sufficiently to permit fluid flow through the casing and to release the plug from the casing. Accordingly, initially maximizing and controlling degradation of structural element 10, rather than speeding ultimate degradation of structural element 10 is a target outcome. The disclosed structure and composition, in some embodiments, does this. A secondary target outcome is that structural element 10 degrades sufficiently so that it will not interfere with further completion and production activities. The disclosed structure and composition does this as well.

Using polyglycolic acid (PGA) illustratively, but without limitation, PGA's degradation in the aqueous downhole fluid produces acid. The produced acid is adjacent to the first part and affects the first part/fluid interface by accelerating degradation of the first part.

Accelerated degradation of the metallic first part further increases the second part's PGA/aqueous downhole fluid surface area (see FIG. 14A). The greater PGA/aqueous downhole fluid surface area accelerates degradation of the second part PGA. These synergistic accelerating effects result in the tool releasing more quickly from the casing than a similarly structured tool, but without this described process, would release from the casing.

In some embodiments, the first part is comprised so degradation of the first part in the aqueous downhole fluid is an exothermic oxidation of a reactive metal, and the second part is comprised so degradation of the second part is accelerated by increasing the temperature at the second part/aqueous downhole fluid surface area. The heat generated by the first part's exothermic oxidation increases the temperature at the second part/aqueous downhole fluid surface area, which increased temperature accelerates the second part PGA element's degradation. This synergistically results in the tool releasing more quickly from the casing than a similarly structured tool, but without this described process, would release from the casing.

In some embodiments, several of the described processes work synergistically to accelerate degradation of the described degradable structural elements in the plug. The first part metal element exothermically oxidizes in the aqueous downhole fluid, and the heat produced by the exothermic oxidation sufficiently speeds degradation of the adjacent hydrolytically degradable polymer elements so the plug releases from the casing before a similarly structured plug would release from the casing without such heat from the metal's exothermic oxidation. Ultimately, degradation of the structural elements of the plug which hold the plug to the casing sufficiently degrade to allow fluid flow through in and around the tool in the casing. This fluid flow accelerates degradation of the plug's degradable elements. The disclosure of U.S. patent application Ser. No. 15/189,090, published as US 2017/0030161 on Feb. 2, 2017, is fully incorporated herein by reference for all purposes. These compositions and processes synergistically cause the tool to release more quickly from the casing than a similarly structured tool, but without the synergistic described processes herein, would release from the casing.

In some embodiments and in some downhole environments, the second part will not degrade quickly enough at relatively low downhole temperatures for the second part to be usefully used or best used as the degradable element causing the plug to release from the casing within the desired period of time. For example, illustratively, the rate of derogation of some PGA compositions in an aqueous downhole fluid is substantially less at a range of between 125° F. to 150° F. than at or above 200° F.; the rate of degradation is substantially less below 125° F. than at or above 150° F. etc. For some purposes, at some temperatures, and in some environments, PGA's lesser rate of degradation at lower temperatures makes use of PGA as a degradable element for causing release of the tool from the casing within a desired period of time relatively impractical. Use of a sufficient amount of a reactive metal which exothermically oxidizes in aqueous downhole fluid to produce heat immediately adjacent a second part element comprised of, for example, PGA or other degradable materials which degrade pursuant to a temperature sensitive process, speeds degradation of such second part elements. Because the heat generated by oxidation of the first part is immediately adjacent and heats the second part/aqueous downhole fluid interface, the first part's generated heat speeds the second part's degradation.

In some embodiments, a plug or downhole tool with some of the constructions and compositions described herein will prevent fluid communication through the casing for a predetermined period of time before allowing fluid communication and ultimately releasing the plug from the casing, i.e. until degradation of the structural elements of the plug which hold the plug to the casing sufficiently degrade so the plug permits communication, and ultimately releases the plug from the casing. In some embodiments, the plug is composed and structured so its rate of degradation produces a predetermined periods of time prior to permitting fluid communication and releasing from the casing sufficient to pressure test zones in the well or sufficient to workover the well. The predetermined periods of time in some embodiments may range from a low of four hours to eight hours or twelve hours to highs of twelve hours, one day, two days or three days from the plug entering the aqueous downhole fluid. In some embodiments, the plug is composed and structured so its predetermined period of time may range from a low of about eight hours to twelve hours or twelve hours, to a high of two days, three days, four days or five days from the plug entering into the aqueous downhole fluid. In some embodiments, the plug is composed and structured so its predetermined period of time may range from a low of one day to two days to three days to a high of one week, two weeks, three weeks, or one month from the plug entering into the aqueous downhole fluid. In some embodiments, the plug is composed and structured so its predetermined period of time may range from a low of one week to three weeks to one month and a high of one month, two months or three months from the plug entering into the aqueous downhole fluid.

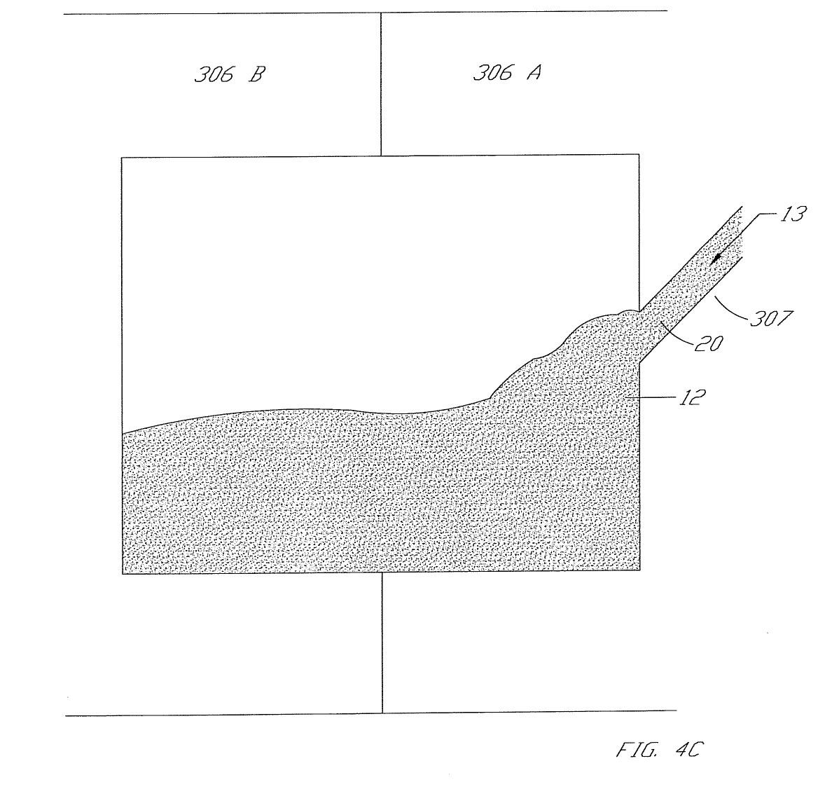

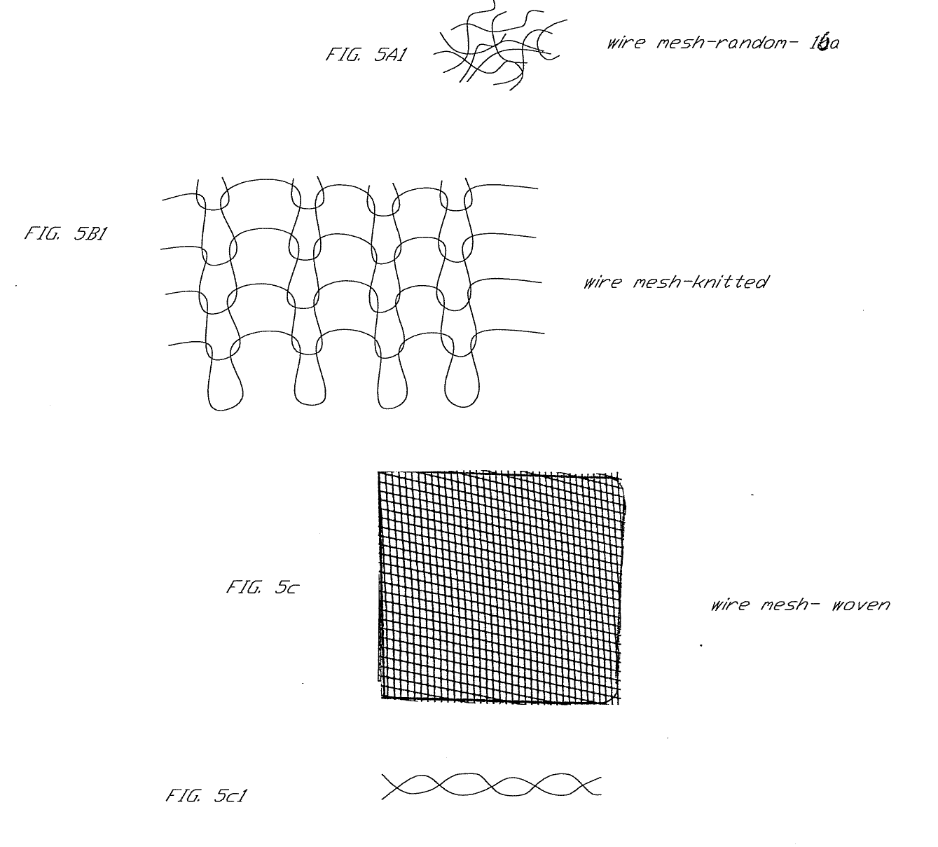

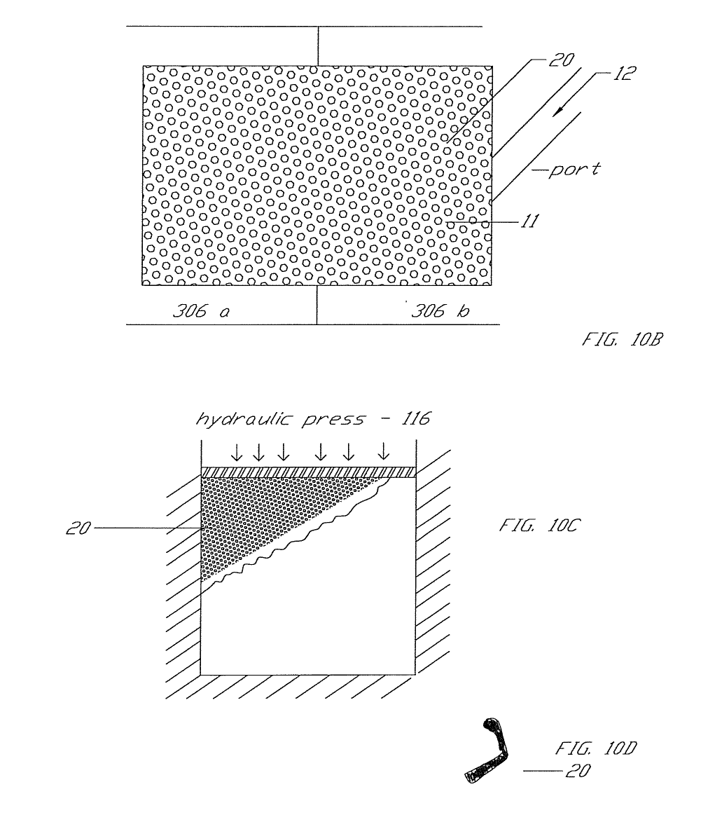

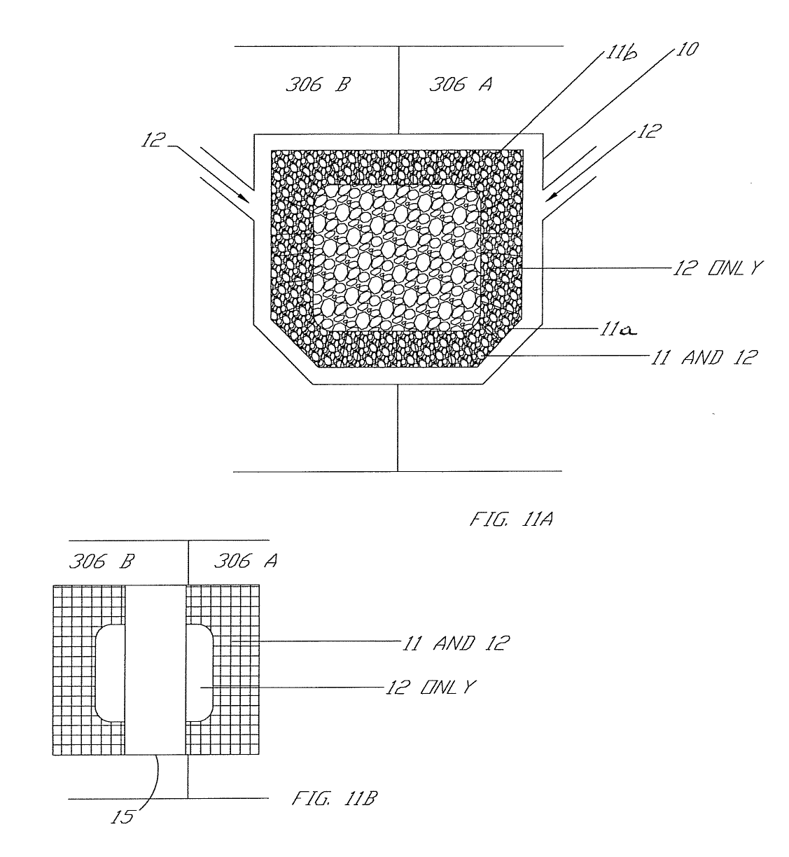

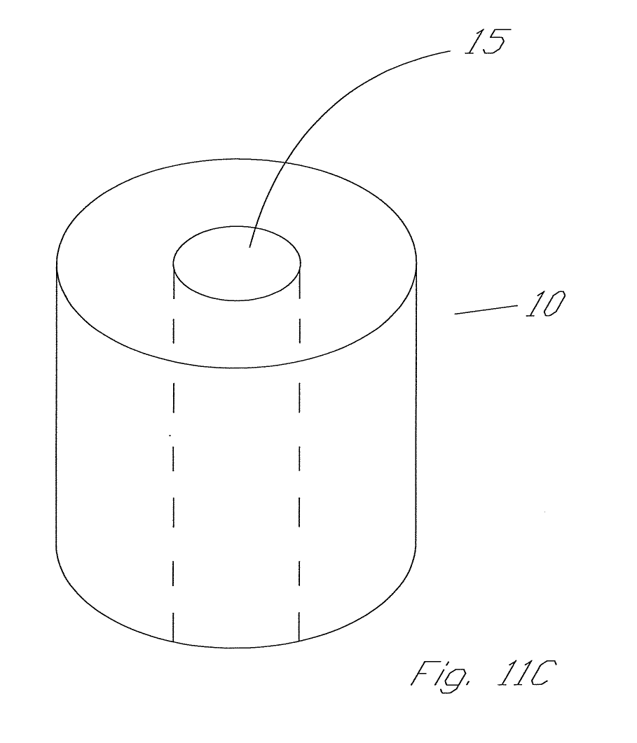

In some embodiments, first part 11 is in any of many shapes that may serve as a matrix, i.e., first part 11 is substantially continuous throughout structural element 10, so as aqueous downhole fluid degrades the portions of first part 11 that are on the outer surface of structural element 10 more quickly than the aqueous downhole fluid degrades second part 12, the more quickly degrading first part 11 opens weaknesses, channels or pits within second part 12, increasing second part 12's surface area in contact with the aqueous downhole fluid. First part 11 when formed of degradable metal may be 100% continuous structures (as seen in FIGS. 1B, 5B1 or 5C, for examples). Other structures, such as formable degradable metal, random particles (see FIG. 10A, for example) of degradable metal or other random structures may provide substantial continuity throughout structural element 10 which is sufficient to cause accelerated degradation throughout the major portions of second part 12 within structural element 10 without being 100% continuous structure of first part 11. As the degradable second part 12 comes into contact with the aqueous downhole fluid, second part 12 degrades, which opens any isolated first part 11 portions to contact with the aqueous downhole fluid, weaknesses, channels or pits.

Referring to FIGS. 1A and 1B, in some structures first part 11 is a strong solid insert for vertical and horizontal strength to structural element 10 (vertical and horizontal being relative to each other only). Where first part 11 is stronger, such as magnesium, than second part 12, such as polyglycolic acid (PGA), use of designs such as shown in FIGS. 1A and 1B may, in some embodiments, enable use of overall smaller elements, such as an expansion cone, and enable use of less of second element 12 material. For example, a cone having a magnesium skeleton first part insert, such as shown in FIGS. 1A and 1B, may use less PGA material and/or be smaller overall than a similar cone without a magnesium first part. A cone such as shown in FIGS. 1A and 1B may do the same functional task within a settable downhole tool with less overall size and/or with less of the more expensive PGA. Additionally, an exemplary cone having pie shaped degradable polymer “slices” separated by magnesium “crusts” as shown in FIGS. 1A and 1B will degrade into smaller chunks downhole due to the PGA and magnesium degrading at different rates and different degradation processes in the aqueous downhole fluid. Other skeleton structures may be used in other downhole tool elements and provide similar benefits.

Referring to FIGS. 1B, 2A, 5A, 5A1, 5B, 5B1, 5C, and 10B, it is seen that first part 11 may include a variety of inserts, which may be configured to fit into a mold space into which the injectable material or moldable material of second part 12 will be injected. These inserts may comprise a solid, rigid insert 14 as seen in FIG. 1B; a non-rigid open cell skeleton insert 16 material as shown in FIG. 2A or a non-rigid, random fiber mesh 16a (comprising intertwined but not necessarily directly connected fibers like a Brillo pad) (see FIG. 5A1) (non-rigid means collapsible under slight pressure, such as a “Chore Girl” scrubbing pad), a stiff, rigid, open or partially open cell skeletal insert 18 as seen in FIG. 5A, such as a magnesium or magnesium alloy foam metal or die pressed, knitted wire mesh (wires ordered, not random). The inserts illustrated in FIGS. 5A, 5A1, 5B1, and 5C may be made, in some embodiments, from metal wire and may be called “wire mesh inserts” and typically have open cells some or all of which may be at least partly filled by the second material during an injection molding process. The insert of FIG. 5A is foam metal (not wire or fibers) and the insert of FIG. 1B may be machined from solid metal or cast from molten metal. FIG. 10B illustrates the use of metal shavings (see FIG. 10A) as an insert comprising first part 11 for a structural element 10 comprising a first part and a second part.

A granular or chips, powder or shavings flowable metallic material (comprising multiple separate small pieces) such as a granular metallic material 20, such as shown in FIG. 5B, may be used and included in the term “insert,” which means a structure configured to be placed in the mold and partly filling the mold, before the injection step or coming into a mold as part of slurry 13. The powder, chip, shaving or granular metallic material as seen in FIG. 5B may flow into the mold, as slurry 13, and typically be evenly disbursed throughout the compound part or structural element 10 (see FIG. 4C). The flowable material may be non-granular, like shavings (see FIG. 10D), an individual shaving typically thin, with widths and lengths many times greater than their thickness dimension.

FIG. 3 illustrates an injection molding machine 300, in simplified form. Injection molding machine 300 typically includes an injection unit 302 and a clamping unit 304. Clamping unit 304 acts on a mold 306, which may have two parts, 306a and 306b. Feed hopper 308 may channel a feedstock 312 (such as polyglycolic acid pellets or other degradable pellets 312a, comprising second part 12) into a motorized, heated screw 310, which injects the thermal plastic or heated feedstock comprising second part 12 under pressure into mold 306. The mold may include: solid insert 14, skeletal non-rigid insert 16 or skeletal stiff or rigid open or partly open insert 18 or any other insert disclosed herein, before second part 12 is injected. In some embodiments, the hot, fluid second part 12 flows around and through the open spaces of the insert to substantially encapsulate some or all of the insert. In one embodiment, slurry 13 of second part 12 (at feedstock 312a) and first part 11 comprising granular, powder, chip or shaving material 20 (at feedstock see 312c) is injected into an open mold, or an empty mold and then is allowed to cure or set. In a second embodiment, the slurry is injected not into an open mold, but into a mold containing an insert, thus a “mixed” degradable part or structural element is formed—from a degradable metal first part and a second part comprising an injectable material with a granular, degradable metal. Note that slurry may contain fibers, 312b at feedstock, which fibers may be metal or non-metal and degradable or non-degradable.

The mold may provide the final shape of the part necessary for the downhole tool, or the mold may provide a solid form or billet (see FIG. 2B), which may be machined. A finished machine part, structural element 10, is illustrated in FIG. 1A. In some embodiments, structural element 10 comes out of the mold as a solid form dimensioned to be directly usable in the downhole tool, rather than as a solid form or billet, which requires machining following removal from the mold.

FIG. 2B also illustrates that outer surface 10a may be comprised partly of degradable first part 11 and partly of cured or set, injected material or second part 12, which in some embodiments may also be degradable in downhole fluids. FIG. 2B illustrates that at least a portion of the interior 10b of structural part 10 also contains a first part and second part 10a/10b, typically in uniform distribution.

FIG. 4A illustrates rigid, solid insert 14 in mold 306, mold 306 having port 307 through which injectable second material 12 may flow, typically heated and under pressure. In FIG. 4A, solid, rigid insert 14 of FIG. 1B is in the mold and second material 12 sets up around all or part of the solid, rigid insert 14. In some embodiments, a space, such as central space 14a (see FIG. 1B) is left unfilled during the mold filling process, but the spaces around the “fins” outside of the central open insert structure are filled with material of second part 12.

In FIG. 4B, any insert partially fills the open mold 306 and the injected material of second part 12 fills in and around the wire comprising the insert (see, for example, FIG. 4B). In FIG. 4C, granular material 20 flows into the mold space intermixed as slurry 13, with thermoplastic first part 12 through port 307.

When the injected material comprising second part 12 cures or sets, the mold is open and the part is removed as a solid form. It may or may not be machined to final dimensions for use of the downhole tool or if it is a finished piece, see FIG. 1A, it may be cleaned up, deburred and used without machining or without substantial machining for use in the downhole tool.

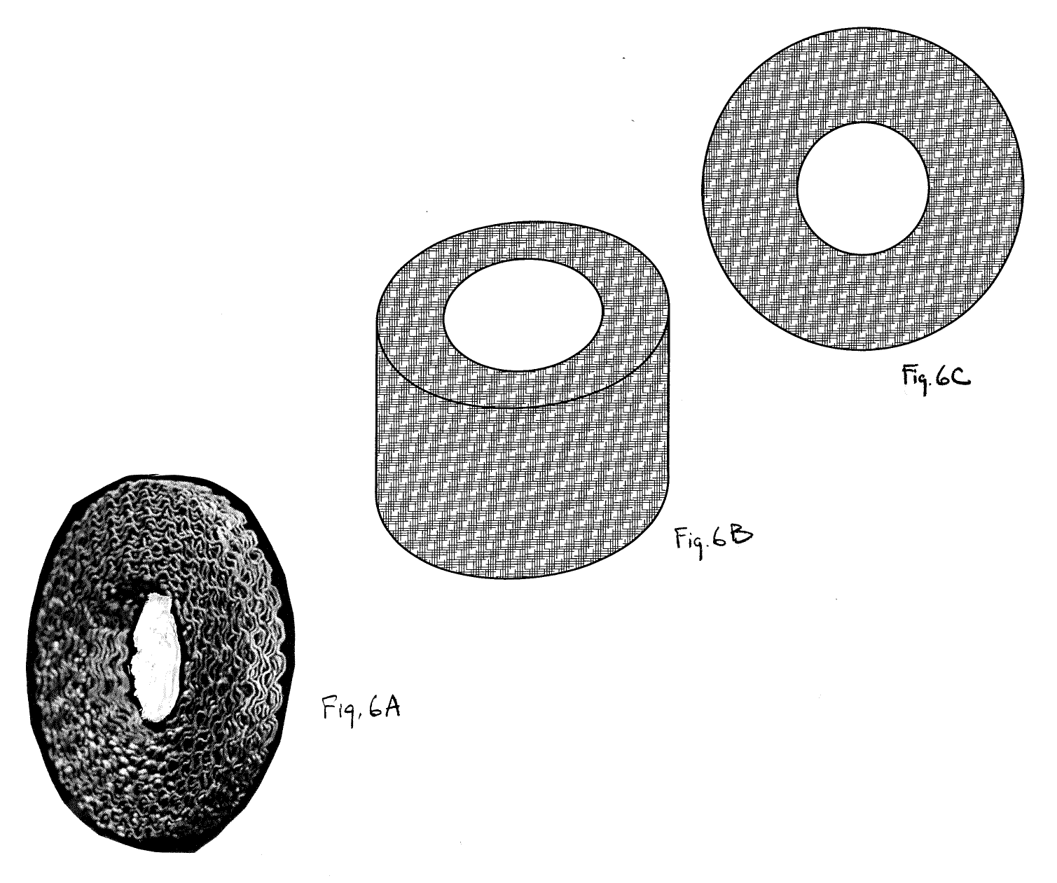

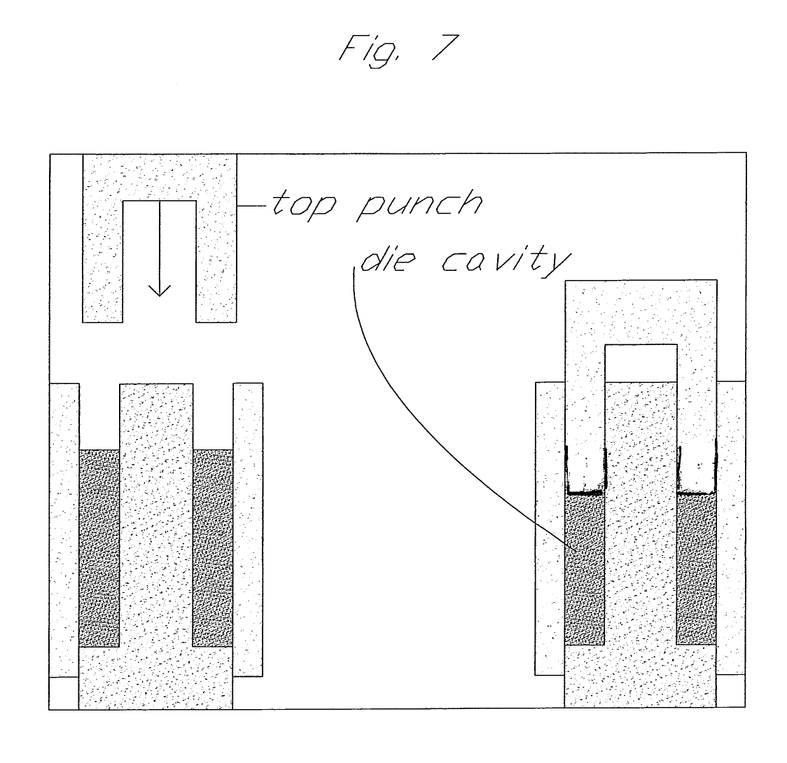

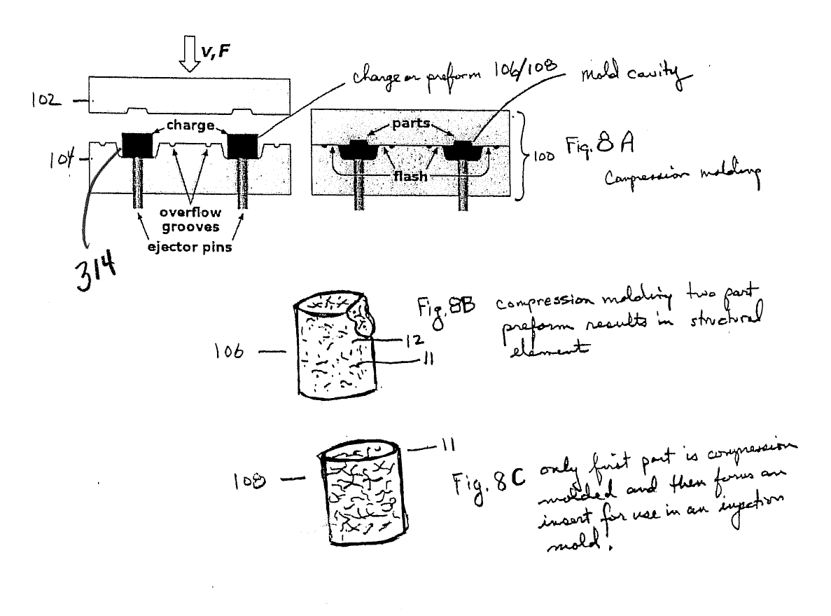

Skeleton or mesh inserts are typically made of wire or the like, having a diameter or shortest dimension ranging between 1 mil and 250 mil. Such wire type or mesh inserts may be aluminum, magnesium or any metal, including metal alloys, that may dissolve or degrade in downhole fluids. The wire inserts may be a mesh made from randomly oriented fibers (see FIG. 5A1—random separate fibers intertwined to form a mesh or FIG. 5A—a foam metal insert) or ordered wire (see FIGS. 2A, 5B1, and 5C, for examples). Ordered wire may be woven, knitted, wire cloth, metal gauze or other suitable form with a regular cell structure repeated many times. In some embodiments, wire skeletons may be die pressed to form a rigid structure for subsequent placement in the mold prior to injection molding. In some embodiments, these prepressed rigid structures may start as random, woven or knitted wire mesh (see FIGS. 6A, 6B, 6C, and FIG. 7). For ordered wire mesh or foam metal, the pore density may be between about 5 ppi and about 60 ppi (pores per inch). Porosity for foam metal inserts may be between 75-96%, in some embodiments. Cell size (longest dimension) for skeletons may be between 0.016″ and 1″ in some embodiments.

FIG. 5A1 illustrates wire mesh comprised of multiple individual strands of wire intermeshed with each other in a random fashion, in the nature of “steel wool.” FIG. 5B illustrates a knitted wire mesh which is comprised of interlocking wire strands forming regular shaped, repeatable loops. FIG. 5C illustrates wire mesh woven in an ordered herringbone weave (see also FIG. 5C1), similar to a wire mesh of a screen door. In some embodiments, first part 11 of structural element 10 is dissolvable magnesium knit mesh (see FIG. 5B1, for example). In some embodiments, the wire mesh is die pressed before placement into the mold (see FIGS. 6A, 6B, and 6C). FIGS. 6A, 6B, 6C, and FIG. 1C illustrate a variety of pressed mesh inserts created, in some embodiments, by die pressing knitted wire mesh.

Second part 12 of any other embodiments herein may be a moldable material, such as polyglycolic acid, polylactic acid, Domomide, injection moldable nylon-like material with or without glass in it, glass filled PEEK, or glass filled plastics. The various materials comprising second part 12 may be molded, compression molded, injection molded or over molded (including insert molded) to the downhole tool structural element shapes to make final parts for the downhole tool. In some embodiments, the inserts both make the structural element 10 stronger and more dissolvable in downhole fluids than structural element 10 would be without the metal skeletons or inserts.

FIG. 7 illustrates a process for die pressing knitted wire mesh (or any other mesh, particulate or pressable skeleton) into a wide variety of insert forms, densities and permeabilities. Typically, wire mesh inserts are placed into a die cavity (typically shaped to the desired insert shape) and a top punch lowered to compress the wire mesh to a set pressure or size. Once ejected, the mesh component is rigid and holds the form of the die cavity. The size, effective density and permeability of the insert is affected by the wire material—here, in some embodiments, a first material that will dissolve in downhole fluids. The size, effective density and permeability of the insert is also affected by the type of material used, and the maximum pressure in the die. Increased pressure in the die makes a more compact and less permeable insert. FIG. 7 shows a cross section of a cylinder of mesh being compressed for subsequent placement into a mold. More complex shapes can be made by the changing the profile of the die and punches. A die pressed wire mesh shape may be removed from the die and placed in the mold. Injection of material comprising the second part into the mold fills the mold's open areas.

In some embodiments the first part is made from dissolvable aluminum or magnesium or any other dissolvable metal. When the first part is made from wire, the wire may be drawn from dissolvable magnesium, such as magnesium alloy from Magnesium Elektron under the trademarks SoluMag or dissolvable magnesium, such as that available from Bubbletight. This dissolvable wire metal may be randomly oriented (see FIG. 5A1), to form a randomly oriented wire mesh which may or may not be die pressed to form an insert. Alternatively, drawn wire from these degradable metals may be used to form randomly ordered fibers or a wire mesh skeleton (rigid or non-rigid) that is knitted, woven or formed into any other ordered structure, rigid or non-rigid which structure may be die pressed into shapes which will ultimately form the insert of a mold to be injected with a material comprising second part 12. When die pressed metal such as die pressed knitted wire mesh is used, it may be die pressed into a shape conforming to the final shape of structural element 10. For example, a magnesium die pressed knitted wire mesh may be die pressed to form a cylinder that may comprise a mandrel, cone or ring for a downhole tool. Such a first part 12 may be placed in an injection mold that conforms to the shape of the die pressed insert and the pore spaces in the insert may be filled with pre-cured injectable materials such as polyglycolic or polylactic acid polymer. When the injected material cures or sets, the resulting structural element 10 is removed from the mold, in some embodiments, needing little or no machining to be used as a dissolvable mandrel or other part of a settable downhole tool.

Illustratively, at temperatures of 180° F. and higher, polyglycolic acid (“PGA”) may degrade more quickly than magnesium, while at temperatures below 180° F., magnesium tends to degrade more quickly than PGA. PGA degradation produces acid that accelerates magnesium degradation. Magnesium degradation produces heat, accelerating PGA degradation. Some magnesium formulations degrade faster but have poor mechanical properties. Paring such formulations as a part one or part to with a part two or part one material with better mechanical properties produces a more usable structural element. Magnesium degradation produces magnesium hydroxide Mg(OH)₂, a clay-like poorly soluble material which may insulate remaining undegradated magnesium from the drilling fluid, impeding further degradation. Interspersing a different degradable material, such as PGA as taught by this disclosure, reduces this problem. Accordingly, downhole tools comprised in part of a material that poorly degrades below a certain temperature may be usefully used as a degradable tool at lower temperatures by including a material which degrades at a lower temperature and/or degrades exothermically. Illustratively, in some embodiments, tools with structural elements comprised of PGA may degrade within the time period specified herein at temperatures of less than 180° F., less than 150° F., and less than 125° F.

As taught by United States patent application Publication No. US 2017/0234103 and PCT/GB2015/052169, both incorporated herein by reference, the degradation reaction of a magnesium degradable in an aqueous downhole fluid, such as SoluMag magnesium, and the degradation reaction of a polyglycolic acid degradable in an aqueous downhole fluid, such as Kuredux polyglycolic acid, when the magnesium and polyglycolic acid are degraded together in an aqueous downhole fluid, may synergistically accelerate both the degradation of the magnesium and the degradation of the polyglycolic acid of structural elements 10. The polyglycolic degradation hydrolysis reaction produces acid. Acid accelerates the magnesium degradation reaction. Both the magnesium and the polyglycolic degradation reactions produce heat. Heat accelerates both the magnesium and polyglycolic degradation reactions. In some embodiments, the degradation rates of the metal used are found in PCT/GB2015/052169 and the degradation rates of the polymer acid (polyglycolic acid or other degradable polymer and the compositions of those polymer acids are found in US 2016/0289374, both of these incorporated herein by reference. Additional degradation rates of metal and degradable resin compositions may be found in US 2017/0284167 incorporated herein by reference.

These accelerating inputs of the magnesium and polyglycolic degradation reactions upon each other are magnified by structural element 10 directly interspersing the magnesium and the polyglycolic acid together as taught herein. The more rapid degradation of the magnesium strands of shavings or wire structural element 10 in contact with the aqueous downhole fluid relative to the degradation of the polyglycolic acid portion of structural element 10 creates weak areas, such as channels or pits within the polyglycolic acid portion of structural element 10 in creates heat at the PGA/downhole fluid surfaces. These channels or pits in the polyglycolic acid portion of structural element 10 increase the polyglycolic acid surface area available to the degradation causing aqueous downhole fluid relative to a similar structural element 10 without such channels or pits. Because these degradation reactions are occurring at strand, mesh, bead or similar relatively small surface sizes and over a relatively large surface areas, the synergistic degradation effects caused by the many small sized interspersions of magnesium throughout the polyglycolic acid portion of structural element 10 are greatly magnified relative to the synergistic degradation effects taught by United States patent application Publication No. US 2017/0234103, incorporated herein by reference.

In some embodiments, the relative volume of parts 11/12 in structural element 10 (ignoring space from which injection moldable second material 12 is intended not to reach after removal, see central space 14a, FIG. 1A) is between about 80%/20%, parts 11/12 or 20% to 80%, parts 11/12. In other embodiments, it may be between 70-80% and 30/70%. In still other embodiments, it may be between 60-40% and 40-60%. In still other embodiments, it is between 5 and 60% and 60 and 5%. In some embodiments, degradable wire strands help accelerate solution channeling into the interior of the structural element when exposed to a downhole fluid.

A useful result of these synergistic degradation effects is that the downhole tool of which structural element 10 as taught herein is a part releases from the well's casing substantially more quickly than a similar tool with a similar structural element 10 which lacks the magnesium interspersed with polyglycolic acid structure as taught herein. Likewise, a downhole tool which structural element 10 as taught herein as a part will quickly become more millable than a similar tool with a similar structural element 10 which lacks the magnesium interspersed with polyglycolic acid structure is taught herein.

In some embodiments, first part 11 is a solid insert or structure which provides structural strength to structural element 10. Hydrolysis of the degradable polymer produces acid which attacks the metal and more quickly reduces structural strength of structural element 10 relative to a similar element without such acid.

In one preferred embodiment, the mesh is made from SoluMag™ magnesium alloy. SoluMag™ alloy is a product of Magnesium Elektron, Madison, Ill. It is a high strength, high corrosion rate alloy that has been used for hydraulic frac balls in downhole frac tool applications. SoluMag™ is a high ductile magnesium alloy that has a high corrosion rate in aqueous and aqueous fluoride environments and is easily machined and is capable of being extruded as small as wire. The degradation of SoluMag™ in an aqueous fluoride environment results in using water in reaction with the magnesium to form magnesium hydroxide, hydrogen gas, and heat.

SoluMag™ wire may be used to form any of the meshes described herein, including the die pressed knitted wire mesh. In some embodiments of Applicant's invention, the degradable magnesium alloy is combined with a polymer acid, in one embodiment, Kuredux, a degradable polyglycolic acid available from Kureha. In an aqueous solution, the polyglycolic acid will auto-catalyze by lowering the pH of the solution, which accelerates the degradation of SoluMag™, in a solid-nonmetallic insert injection molded or over-molded or compressed molded as part of the interior of a cone for a settable downhole tool. Illustratively, in some embodiments, tools with structural elements comprised of PGA may degrade within the time period specified herein at temperatures of less than 180° F., less than 150° F., and less than 125° F.

Although some of the embodiments described herein employ magnesium as a component of first part 10, it is understood that the use of magnesium is exemplary only and not limiting. Other metals which are reactive in an aqueous downhole fluid may be similarly useful. Although some of the embodiments described herein employ a polyglycolic or polylactic acid as a component of second part 12 herein, it is understood that the use of polyglycolic or polylactic acid is exemplary only and not limiting. Other polymers which produced acid may be similarly useful.

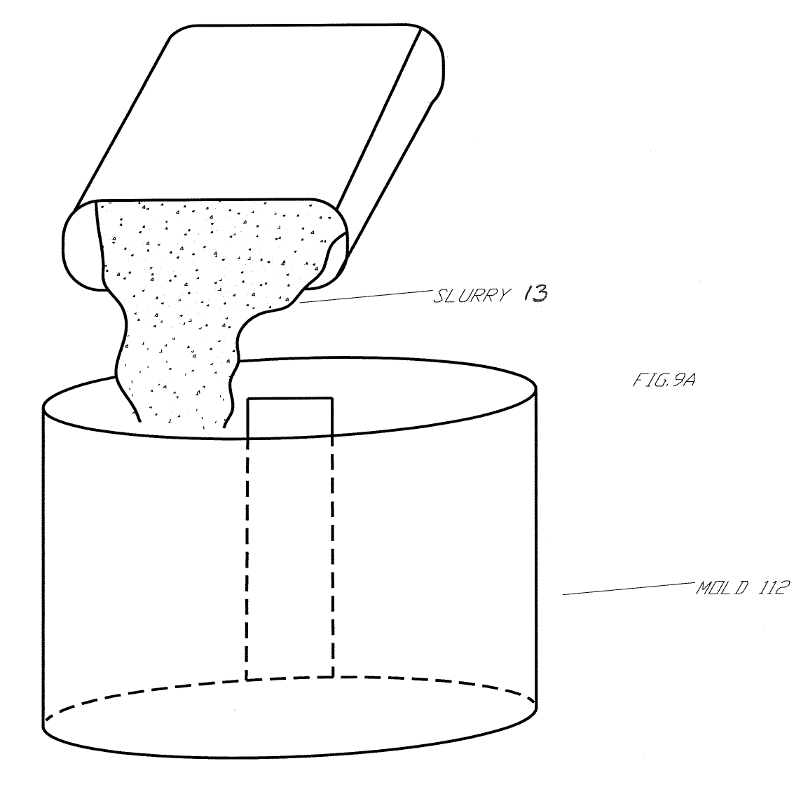

In some embodiments, compression molding may be used to create two-part structural element 10. Compression molding is a method in which a molding material is first placed into an open heated mold cavity 314 (see FIGS. 8A, 8B, and 8C). As seen in FIG. 8A, there may be two parts, a plug 102 and a base 104. The mold 102/104 is closed with a top force on plug member 102 and pressure is applied to force the material, here charge or preform 106/108 into the mold shape. Charge 106 may comprise a mixture of first part 11 and second part 12, see FIG. 8B. Charge 108 may comprise a first part only see FIG. 8C, which, when compression molded, forms an insert for use in a subsequent injection molding step (see FIG. 3). The mold may be heated. Charge 106/108 may also be heated before compression. Inserts, such as those described herein, including metallic inserts, may be compression molded with or when enmeshed with or enmeshed in second part 12, resulting in structural element 10. To make clear, compression molding may be used to make an insert that will subsequently be placed into a mold with a second part injected there into (see FIG. 3) or, compression molding can be used to make the structural element when the preform or charge comprises two parts 106/108 of which one part (or both) may be degradable.

Compression molding typically starts with an allotted amount of material placed over or inserted into the mold 102/104. In some embodiments, the charge may be heated to a pliable state in and by the mold. Shortly thereafter, the hydraulic press compresses the charge resulting in a molded piece which retains the shape of the inside surface of the mold. After the hydraulic press releases, an injector pin in the bottom of the mold ejects the finished piece out of the mold. There may or may not be excess material in the mold or flashing on the released piece which may be removed.

In some embodiments, pour molding may be used to create Applicant's two-part structural element 10. FIGS. 9A and 9B illustrate a pour molding method of forming structural element 10 for a downhole tool. In FIG. 9A, slurry 13 comprised of a mix of first part 11 and second part 12 is poured into an open top mold 112. Slurry 13 may be heated and in one embodiment is heated sufficiently to form a flowable second part 12. Immersed in slurry 13 are granules, fibers, particles, shavings or the like comprising first part 11 in a solid (unmelted) form. In some embodiments, the temperature of slurry 13 may be above melting or plastic transition point of second part 12 and below a melting point of first part 11. Slurry 13 is poured into the mold and then allowed to cool and cure or set. Upon cooling the mold may be split (it is typically two parts) and structural element 10 removed. In FIG. 9B, the pourable material comprising a melted part second part 12 and first part 11 is packed into the open mold in such a fashion (mesh, random fibers, a skeleton, solid, rigid-FIG. 1B or the like) that there are sufficient openings or void spaces that the pourable, curable material will fill at least some of the openings or void spaces encapsulating or embedding the other, non-poured part before cooling and curing or setting.

FIG. 10A illustrates a type of insert or slurry first part, here metal chips or shavings 20 (collectively “shavings”), here magnesium chips or shavings. These chips or thin strips of metal may be byproducts of metal milling and/or grinding operations. Indeed, they sometimes are literally collected from the machine shop floor. Such shavings are produced from shaving or cutting metal and then collected for reuse. Sometimes nano-crystalline structures are found in metal shavings which possess beneficial traits of high strength and wear resistance. Metal shavings may be used with any of the molding processes or other materials set forth herein. In some embodiments, metal shavings may comprise a metal or metal alloy that is degradable in the downhole fluid. Metal shavings may be placed or packed into a hydraulic press before injection molding or before pouring/injecting second part 12 (see FIG. 10C). When such a first part is used as a rigid (see FIG. 10C) or loose insert in an open mold (see FIG. 10B), the second part may be injectable and may comprise a degradable or non-degradable thermosetting or thermoplastic material which may be a resin. In some embodiments, the second material 12 is an injectable polymer acid such as PLA or PGA that degrades in a downhole fluid. This forms structural element 10 that may have a degradable first part which is metallic and also a degradable (or non-degradable) second part which is nonmetallic. The insert typically helps make the part stronger.

Alternatively, one of the first or second materials may be nondegradable, the resulting structural element nevertheless failing downhole upon the other degradable element degrading enough to cause structural element 10 to lose structural integrity.

Shavings 20 (FIG. 10B) or other particulates may be used as first part 11 in a least three ways: placed loosely (non-integrated) into the open mold; compressed to an integrated (not loose) mass (that, in some embodiments, has about 5-60% open space), and then placed into the mold; or as part of a slurry. FIG. 10C shows a hydraulic press used to compress loose shavings under thousands of pounds of pressure so they form an integral mass, but with, in some embodiments, 5-60% open space, which for an insert that is placed into an open mold for subsequent injection molding and curing to form structural element 10.

While the foregoing illustrate inserts comprising, at least in part, a degradable metal, in some embodiments the mold inserts comprising first part 11 may be a degradable or non-degradable nonmetallic material, such as filaments, shavings, particles or mesh of a cured polymer acid. Filaments or mesh comprising polymer acids may or may not be knitted or may be fibrous and may be placed into a mold as a skeleton (that is, ordered and/or disordered filaments or wires that are connected) or as random, non-integrated, loose pieces. The second part may be a strong, injectable uncured resin or non-resin such as nylon or PEEK and may be degradable or non-degradable.

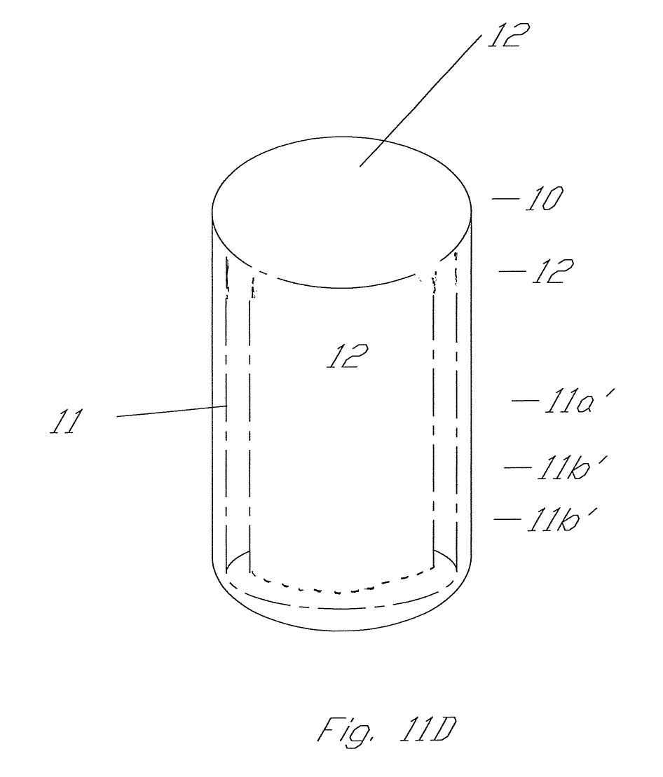

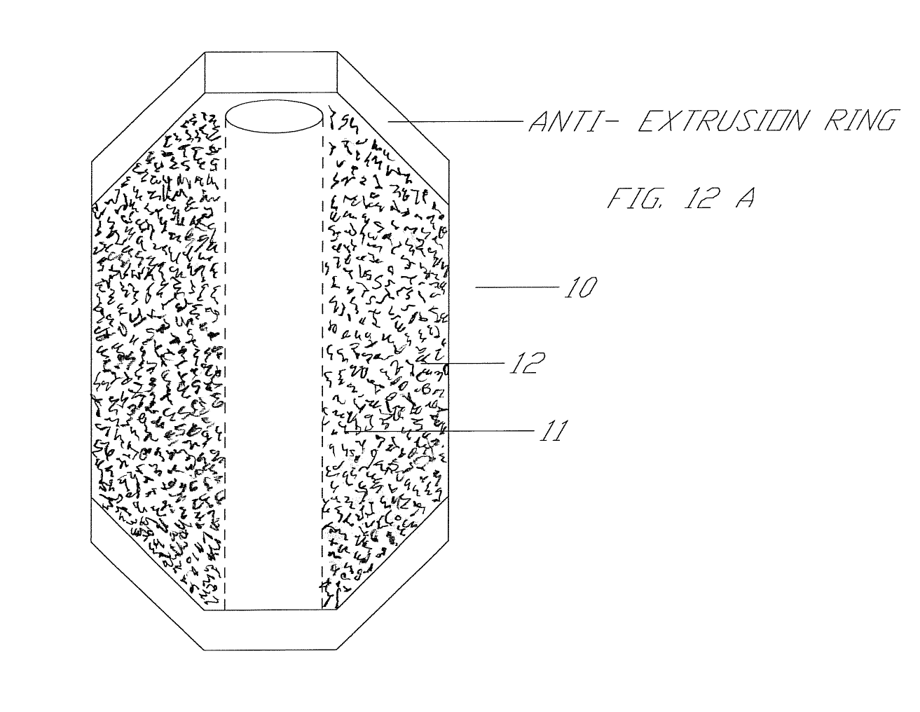

FIGS. 11A, 11B, and 11D illustrate structural elements with part of the element having both first and second parts and part of the structural element comprised of only the second part. FIG. 11A illustrates structural element 10 having first part 11 comprising an insert, here a rigid open cell insert, in a mold following the injection and curing or setting of second material 12. In this embodiment, the insert has some open spaces or cells and second material 12 is injected so it at least partly fills these spaces or cells in a border area 11a, with no first material 11, or almost none, in non-perimeter or core area 11b. Thus, structural element 10 created has a strong “shell” or border area 11a comprising first and second parts 11 and 12 with only the second parts 12 in the non-border regions of structural element 10.

FIG. 11B illustrates first part 11 comprising an insert (such as those disclosed herein) in an open mold into which second part 12 is injected. Insert 11 has been configured, such as by pre-molding or pre-shaping before placing in the open mold, so it partly fills, in a rigid and stiff fashion, some but not all of the open mold. Here the insert is pre-shaped as a hollow cylinder to fill some of the open mold. First part 11 is pre-shaped so that it is adjacent to outer walls of the open mold, but has an open core area. When first part 11 is placed in the mold and second part 12 is injected into the mold, the resulting structural element 10 will have a border region of both parts 11 and 12, such as that seen in FIG. 11A, except that the part of structural element 10 not comprised of both 11 and 12 (mixed) is the injectable second part 12.

Many of the structural elements 10 illustrated herein may appear from some of the illustrations to be solid cylindrical elements when released from the mold following curing, but more typically the mold creates a structural element with a cylindrical shape having a central open longitudinal channel 15 (see FIG. 11C). Many structural elements 10 intended for use with a settable downhole tool have this open cylinder so as to slide onto and encircle a mandrel—including rings, cones, wages, slips, elastomers, sealing elements, anti-extrusion rings or the like (see FIG. 11C, for example).

FIG. 11D illustrates an area 11a′ comprising both first and second parts 11/12, here “encapsulated” first part 11, encapsulated within second part 12. Area 11b′ comprises only second part 12. This embodiment exposes little or no insert material to the surface of the compound part. It may add strength, but avoid corrosion of first part—at least the first part material not exposed to the outer surface of the compound part 10.

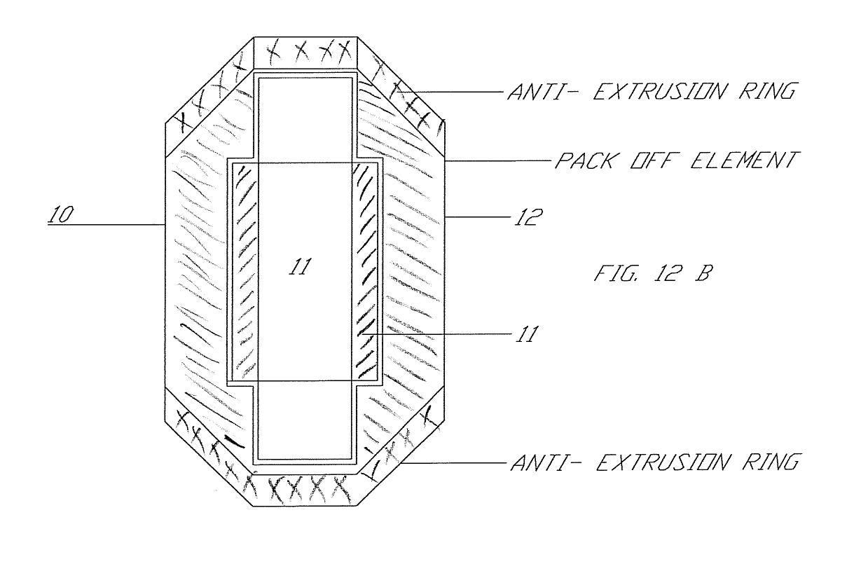

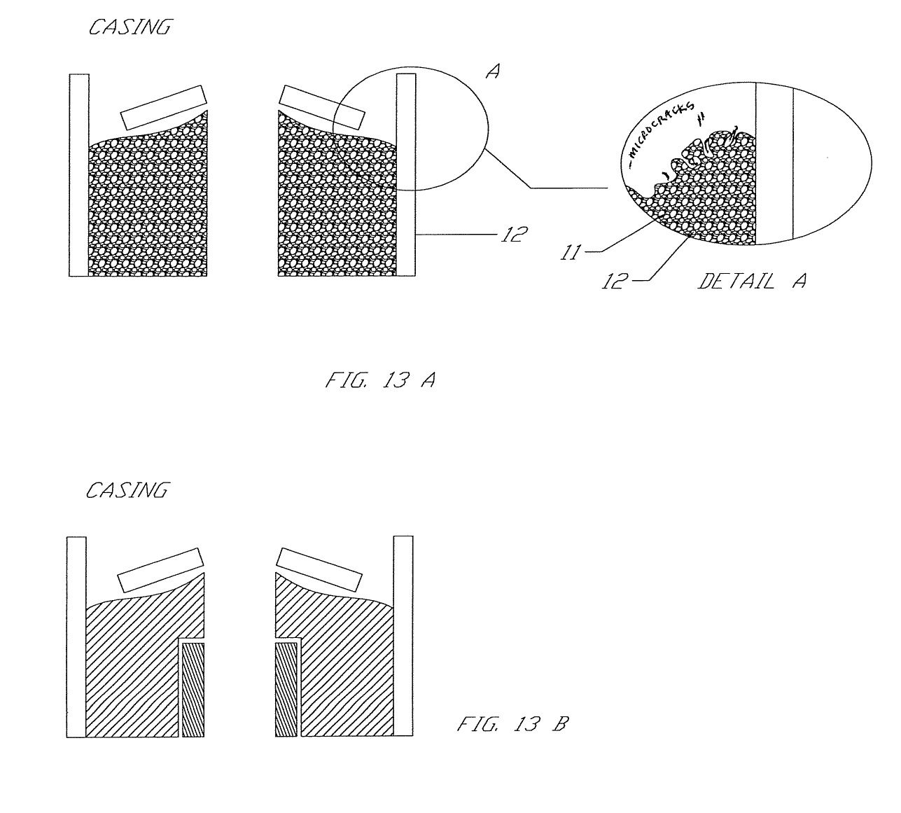

FIGS. 12A, 12B, 13A, and 13B illustrate structural elements 10 that are elastomeric and suitable as packoff or sealing elements in a settable downhole tool. In some embodiments, the structural element of the downhole tool may comprise a first part inner core about which is molded a second part outer layer, for example, a seal comprised of a hard first part inner core and an elastomeric second part outer layer, or the like. Such an elastomeric second part outer layer may be comprised of rubber, silicone or other elastomeric materials used in a downhole tool's seal to seal the tool against the casing. In some embodiments, the injection molded structural element of the downhole tool may be an injection molded seal for sealing the tool against the casing. Published Application US2017/0016298, incorporated by reference herein, illustrates a degradable rubber that may be molded, including injection molded and used as a suitable second part 2. FIG. 12A illustrates a degradable elastomer as second part 12 of a structural element 10 comprising a packoff or sealing element of a downhole tool. First part 11 may be any of the first part-inserts disclosed herein or a first part that forms a slurry to enter the open mold. First part 11 may be degradable or non-degradable.

FIGS. 12A, 12B, 13A, and 13B illustrate structural element 10 having first part 11 and second part 12, wherein second part 12 is, in some embodiments, a material that will set or cure to form a moldable elastomer that may or may not be degradable. Elastomers, such as disclosed in the '298 publication incorporated herein by reference, may be degradable and may be used as packoff elements (sealing elements) in a settable downhole tool. Thermoplastic elastomers (TPEs) or TPU (thermoplastic polyurethane) may be injection molded, and may be used with Applicant's inserts illustrated herein or may be mixed to form a slurry with granules, shaving or the like and injected into an open mold. The result of one of the first or second parts, or both of the first or second parts comprising a degradable material and/or a degradable material which is an elastomer is a structural element 10 having, upon curing or setting, two parts, one of which is injection moldable and elastomeric. Such a structural element 10 may be used as a packoff or sealing element in a settable downhole tool.

FIGS. 12A and 12B illustrate embodiments of a two-part elastomeric sealing element in which one part is an insert, and a second part is an injection moldable rubber, TPE, TPU or other suitable material. FIG. 12A illustrates first part 11 which, in some embodiments, may be shavings of magnesium or aluminum, which may be degradable in the downhole fluid. Second part 12 may be a degradable or nondegradable injection moldable elastomeric material. FIG. 12B illustrates a first part 11 which, in some embodiments, is a rigid metal open cylindrical insert placed into a mold, and second part 12, which is injection moldable around the solid metal insert. Note the length of the rigid insert is less than the elastomer that surrounds it to allow for compression during setting. First part 11 may be a metal, such as magnesium, and may or may not be degradable. Second part 12 may be an injection moldable material, which may be over molded or insert molded or otherwise formed or placed on or around first part 11 to form an elastomeric packoff element with a rigid core. Both FIGS. 12A and 12B show anti-extrusion rings around the structural element 10 and both illustrate the preset position.

FIG. 13A and Detail A, and FIG. 13B illustrate partial views of structural elements 10, here the elastomeric packoff elements of FIGS. 12A and 12B in a post set position, that is, with some of the elastomer squeezed outward during setting and in contact with the casing walls. In some embodiments, the packoff element in FIGS. 12A and 13A may include as first part 11 small flakes, fibers or shavings of magnesium or other metal insert encapsulated in an elastomeric second part 12. First part 11, in some embodiments, is not elastomeric and second part 12 is elastomeric. Thus, during setting of the tool where the elastomeric material expands around the anti-extrusion rings (see Detail A, FIG. 13A), multiple “micro-cracks” may develop at the interfaces of the individual particles or fibers of first part 11 and the elastomeric material which “micro-cracks” may promote channeling, fracturing, separating and dissolution in the downhole fluid when one or both of the two materials is dissolvable in the downhole fluid. Second part 12 may, in some embodiments, be TPU or TPE.

As shown in FIG. 14, in some embodiments, injection molding produces a structural element 10 of a plug, the structural element with radial or longitudinal aligned cavities or inclusions 402/404. Cavities 402/404 may be formed by molding within a mold having internal projections. In some embodiments the cavities are left open and, in some embodiments, are filled (for example, subsequent to curing or setting) with a cavity material which, in some embodiments, may accelerate or slow down degradation of structural element 10 in an aqueous downhole fluid and/or which will make structural element 10 more quickly or slowly degrade or more easily mill up relative to a similar structural element without the cavities and/or without the cavity material. Cavities may, in some embodiments, be filled with a material which will strengthen the compression and/or shear properties of the elements.

Similarly, in some embodiments, some or all of first part 11 may comprise encapsulated members 406 which are comprised of encapsulated material which will make structural element 10 more quickly or more slowly degradable or more easily millable relative to a similar structural element without the encapsulated members 406. Similarly, in some embodiments, some of the first part may be hollow or may encapsulate materials which will accelerate or slow degradation of structural element 10 or make it more quickly millable relative to a similar structural element without the encapsulated materials. Encapsulated members 406 may be selected from materials that strengthen the elements in shear and/or compression. Some of these materials are: metals and metal alloys, composites, and polymers.

FIG. 14A illustrates a structural element 10 in a downhole environment exposed to a downhole fluid. First part 11 comprises a degradable metal and some is initially exposed to a downhole fluid DF. Degradation has begun at the uppermost of the three part 11's shown, which had a portion exposed to the fluid where the part initially contacted the fluid. The lowermost part 11 was not partially exposed (is fully encapsulated) and thus has not yet been subject to degradation.

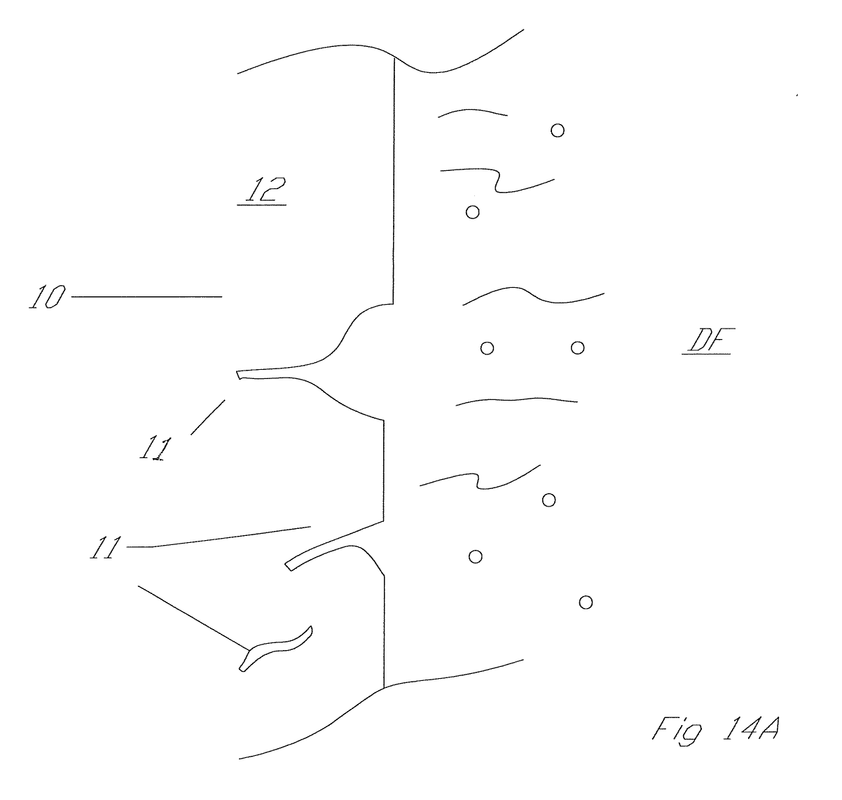

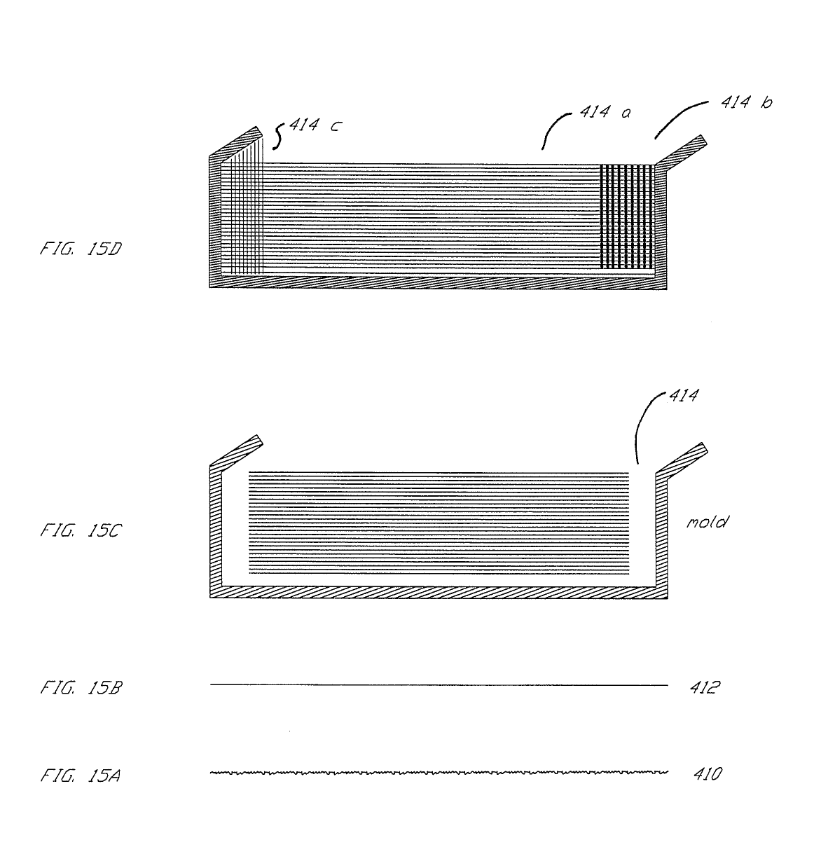

A first part may comprise an insert having multiple continuous fibers, which may act to reinforce the compound part or structural. Illustrated in FIGS. 15A and 15B is a multi-filament fiber 410 (FIG. 15A) and a monofilament fiber 412 (FIG. 15B) that may comprise a continuous fiber of an insert forming an array 414 comprised of multiple continuous fibers. Rather than inserts comprised of short, non-ordered fibers, such as seen in some previous embodiments, these fibers 410 and/or 412 are long and continuous and may be ordered. In some embodiments, they may be degradable metallics and, in other embodiments, they may be degradable nonmetallic materials, such as a glass. Multi-filament fibers may be comprised of multiple strands woven together and monofilament fibers are a single-strand or filament. FIG. 15C illustrates an array of parallel aligned continuous fibers laid next to one another and oriented with respect to the axis of a mold. In FIG. 15C, array 414 is comprised of multiple parallel fibers aligned with the longitudinal axis of the mold and providing compressive strength to a structural element resulting from the molding process. FIG. 15D illustrates that one or more arrays may comprise an insert where the fibers of the arrays are oriented along different axes of the mold. Here the arrays 414a/414b/414c are oriented along a length, width and height axis of a mold and may comprise a compound part having compressive strength along all three axes.

The fibers may also be degradable in a downhole fluid, but also non-chemically degrading, but physically degradable, for example, in downhole flow-back conditions. For example, if one were to reinforce a degradable polymer with long glass fibers, when a flow back condition exists with an abrasive fluid, that glass will flow back and break apart into small particles as it goes. Without the polymer to keep it from bending past its breaking point, it will overflex and break into smaller and smaller pieces. The same process may occur with other typical reinforcing fibers of high tensile strength.

The present invention is adapted to attain the ends and advantages mentioned as well as those that are inherent therein. The embodiments disclosed above are illustrative only, as the present invention may be modified and practiced in different but equivalent manners apparent to those skilled in the art having the benefit of the teachings herein. No limitations are intended to limit the details of construction or design shown, other than as described in the claims below. The illustrative embodiments disclosed above may be altered or modified and all such variations are considered within the scope and spirit of the present invention.

The terminology used herein is for the purpose of describing particular implementations only and is not intended to be limiting. The singular form “a”, “an”, and “the” are intended to include the plural forms as well, unless the context clearly indicates otherwise. The terms “comprises” and/or “comprising,” when used in the this specification, specify the presence of stated features, integers, steps, operations, elements, and/or components, but do not preclude the presence or addition of one or more other features, integers, steps, operations, elements, components, and/or groups therefore. Compositions and methods described in terms of “comprising,” “containing,” or “including” various components or steps, can also “consist essentially of or “consist of the various components and steps.

Whenever a numerical range with a lower limit and an upper limit is disclosed, any number and any included range falling within the range is specifically disclosed. Every range of values (of the form, “from about a to about b,” or, equivalently, “from approximately a to b,” or, equivalently, “from approximately a to b”) disclosed herein is to be understood to set forth every number and range encompassed within the broader range of values. The terms in the claims have their plain, ordinary meaning unless otherwise explicitly and clearly defined by the patentee. If there is any conflict in the usages of a word or term in this specification and one or more patent(s) or other documents that may be incorporated herein by reference, the definitions that are consistent with this specification should be adopted.

The corresponding structure, materials, acts, and equivalents of all means or steps plus function elements in the claims below are intended to include any structure, material, or act for performing the function in combination with other claimed elements as specifically claimed. The description is presented for the purposes of illustration and description, but is not intended to be exhaustive or limited to the implementations in the form disclosed. Many modifications and variations will be apparent to those of ordinary skill in the art without departing from the scope and spirit of the disclosure. The implementations were chosen and described in order to explain the principles of the disclosure and the practical application and to enable others or ordinary skill in the art to understand the disclosure for various implementations with various modifications as are suited to the particular use contemplated. Those skilled in the art will readily recognize that a variety of additions, deletions, modifications, and substitutions may be made to these implementations. Thus, the scope of the protected subject matter should be judged based on the following claims, which may capture one or more concepts of one or more implementations.

Although the invention has been described with reference to a specific embodiment, this description is not meant to be construed in a limiting sense. On the contrary, various modifications of the disclosed embodiments will become apparent to those skilled in the art upon reference to the description of the invention. It is therefore contemplated that the appended claims will cover such modifications, alternatives, and equivalents that fall within the true spirit and scope of the invention.

1. A structural element for a downhole tool, comprising:
a first part and a second part;
the first part comprising a metal capable of degrading in an aqueous downhole fluid and capable of being placed in a mold with the second part, the first part disposed within the structural element such that when the tool is used in an aqueous downhole fluid at least some of the first part is at an outer surface of the structural element, and in contact with the aqueous downhole fluid, and at least some of the first part is not at the outer surface of the structural element;
the second part comprising a moldable material capable of degrading in the aqueous downhole fluid; the second part disposed within the structural element such that when the tool is used in the aqueous downhole fluid at least some of the second part is not at the outer surface of the structural element; and
the structural element capable of degradation more quickly in the aqueous downhole fluid than a similar structural element comprised solely of the second part will degrade.

2. The structural element of claim 1, wherein the first part comprises an at least partly open cell metallic skeleton.

3. The structural element of claim 2, wherein the at least partly open cell skeleton is non-rigid.

4. The structural element of claim 2, wherein the at least partly open cell skeleton is rigid.

5. The structural element of claim 4, wherein the rigid, at least partly open cell skeleton is die compressed knitted wire magnesium alloy or aluminum alloy.

6. The structural element of claim 4, wherein the rigid, open cell skeleton is foam metal.

7. The structural element of claim 2, wherein the at least partly open cell skeleton is made of metal wire.

8. The structural element of claim 7, wherein the wire is aluminum alloy or magnesium alloy.

9. The structural element of claim 7, wherein the average diameter or average shortest dimension of the wire is between 2 and 250 mil.

10. The structural element of claim 7, wherein the wire is an ordered wire mesh.

11. The structural element of claim 7, wherein the wire is woven wire mesh.

12. The structural element of claim 7, wherein the wire is knitted wire mesh.

13. The structural element of claim 12, wherein the knitted wire mesh is capable of being die compressed.

14. The structural element of claim 1, wherein the second part is a polymer acid degradable in the aqueous downhole fluid.

15. The structural element of claim 1, wherein the first part is comprised of multiple metal particles.

16. The structural element of claim 15, wherein the metal particles are granular metal or metal shavings.

17. The structural element of claim 1, wherein the first part comprises a rigid, solid insert.

18. The structural element of claim 1, wherein the first part comprises randomly arranged metal fibers.

19. The structural element of claim 1, wherein the first part comprises long, ordered fibers.

20. A method of making a structural element for a downhole tool, the method comprising the steps of:
providing a mold having a mold cavity;
partly filing the cavity with a first material comprising an insert;
filing the mold cavity with an uncured or unset second material, the second material comprising a material in a plastic or fluid state, the second material at least partly encapsulating the first material;
allowing the second material to cure or set to a solid form; and
removing the form from the mold cavity;
wherein at least one of the first or second material is degradable in a downhole fluid.

21. The method of claim 20, further including the step of machining the form.

22. The method of claim 20, wherein the mold of the providing step includes internal projections.

23. The method of claim 20, wherein the partly filing step and the filling step are accomplished simultaneously with a slurry comprising a mixture of the first material and the second material filling the mold cavity.

24. The method of claim 20, wherein the insert of the partly filing step is a rigid body with open cells.

25. The method of claim 20, wherein the insert of the partly filing step is a skeleton with open cells.

26. The method of claim 25, further including prior to the partly filing step, the step of preforming the skeleton into a skeleton configuration.

27. The method of claim 26, wherein the skeleton configuration is tabular.

28. The method of claim 26, wherein the skeleton configuration is cylindrical.

29. The method of claim 26, wherein the preforming step includes compressing the skeleton.

30. The method of claim 25, wherein the skeleton is capable of degrading in a downhole fluid.

31. The method of claim 25, wherein the skeleton is comprised of ordered, open cells.

32. The method of claim 25, wherein the skeleton is comprised of irregular, open cells.

33. The method of claim 20, wherein the insert of the partly filing step is comprised of multiple loose particles.

34. The method of claim 20, wherein the insert of the partly filing step is comprised of foam metal.

35. The method of claim 20, wherein the insert of the partly filing step is comprised of long fibers.

36. The method of claim 20, wherein the second material cures or sets to form an elastomer.

37. The method of claim 20, wherein the insert is comprised of aluminum or magnesium wire or shavings.

38. The method of claim 37, wherein the wire or shavings are die pressed before the partly filling step.

39. The method of claim 20, wherein the filling step includes the step of compressing.

40. The method of claim 20, wherein the filling step includes the step of pouring the second material.

41. The method of claim 20, wherein the filling step includes the step of injecting the second material.

42. A structural element for a settable downhole tool, the structural element comprising:
a first part comprising a metal capable of degradation in an aqueous downhole fluid and configured to fit into a mold; and
a second part comprising a moldable material.

43. The structural element of claim 42, wherein the settable downhole tool will release from a well's casing more quickly than if the structural element were comprised solely of the second part.

44. The structural elements of claim 42, wherein the settable downhole tool will be more millable after two hours in aqueous downhole fluid than if the structural element was comprised solely of the second part.

45. A structural element for a settable downhole tool, comprising:
a first part comprising a metal degradable in an aqueous downhole fluid and capable of being used in an injection mold with a second part comprising a thermoset or thermoplastic material, the first part comprising a skeleton and disposed within the structural element so when the tool is used in an aqueous downhole fluid at least some outer portions of the first part are at the outer surface of the structural element, are in contact with the aqueous downhole fluid, and at least some inner portions of the first part are not in contact with the aqueous fluid; and
a second part comprising an injection moldable material.

46. The structural element of claim 45, wherein the first part comprises an at least partly open cell metallic skeleton.

47. The structural element of claim 46, wherein the at least partly open cell skeleton is non-rigid.

48. The structural element of claim 46, wherein the at least partly open cell skeleton is rigid.

49. The structural element of claim 46, wherein the rigid, at least partly open cell skeleton is die compressed knitted wire magnesium alloy or aluminum alloy.

50. The structural element of claim 46, wherein the rigid, open cell skeleton is foam metal.

51. The structural element of claim 46, wherein the at least partly open cell skeleton is made of metal wire.

52. The structural element of claim 51, wherein the wire is aluminum alloy or magnesium alloy.

53. The structural element of claim 51, wherein the average diameter or average shortest dimension of the wire is between 2 and 250 mil.

54. The structural element of claim 51, wherein the wire is an ordered wire mesh.

55. The structural element of claim 51, wherein the wire is woven wire mesh.

56. The structural element of claim 51, wherein the wire is knitted wire mesh.

57. The structural element of claim 56, wherein the knitted wire mesh is capable of being die compressed.

58. The structural element of claim 45, wherein the second part is a polymer acid.

59. The structural element of claim 58, wherein the second part is degradable in an aqueous downhole fluid.

60. The structural element of claim 45, wherein the first part is granular metal or shavings.

61. The structural element of claim 60, wherein the granular metal or shavings are comprised of a magnesium alloy.

62. The structural element of claim 45, wherein the first part comprises a rigid, solid insert.

63. The structural element of claim 45, wherein the first part comprises randomly arranged metal fibers.

64. The structural element of claim 63, wherein the metal fibers are die pressed.

65. A structural element for a downhole tool, comprising:
a first part and a second part;
the first part comprising a metal degradable in an aqueous downhole fluid and capable of being used in an injection mold with the second part, the first part comprising a skeleton and disposed within the structural element so when the tool is used in an aqueous downhole fluid at least some outer portions of the first part are at the outer surface of the structural element, are in contact with the aqueous downhole fluid, and at least some inner portions of the first part are not in contact with the aqueous fluid;
the second part comprising an injection moldable material degradable in an aqueous downhole fluid; the second part disposed within the structural element so when the tool is used in an aqueous downhole fluid at least some inner portions of the first part are not in contact with the aqueous downhole fluid;
the first part degrades more quickly in aqueous downhole fluid than the second part, and degradation of the first part increases the surface area of the second part in contact with the aqueous downhole fluid; and
the structural element degrades more quickly in the aqueous downhole fluid than a similar structural element comprised solely of the second part injection moldable material will degrade.
